(19) United States
(12) Patent Application Publication
(10) Pub. No.: US 2026/0252153 A1
(43) Pub. Date: Aug. 27, 2026

(54) SERVER POWER SUPPLY SYSTEM

(71) Applicant: SUZHOU METABRAIN INTELLIGENT TECHNOLOGY CO., LTD., Suzhou, Jiangsu (CN)

(72) Inventors: Mingwei WU, Suzhou, Jiangsu (CN); An CHEN, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 19/469,736

(22) PCT Filed: Sep. 2, 2025
(86) PCT No.: PCT/CN2025/118544

§ 371 Date: Nov. 17, 2025

(30) Foreign Application Priority Data
Feb. 27, 2025 (CN) 202510227356.7

(51) Int. Cl. G06F 1/26; G06F 1/28; G06F 1/30

(52) U.S. Cl. CPC G06F 1/263; G06F 1/28; G06F 1/30

(57) ABSTRACT

Provided is a power supply system of a server. A plurality of parallel-connected power supplies are deployed in the power supply system of a server. When a server has a power supply requirement, according to electrical energy parameters of electrical energy output by the plurality of power supplies and a power supply parameter of the power supply system that is configured to indicate a differences between electrical energy that the power supply system allows the plurality of power supply to output, a target power supply among the plurality of power supplies adjusts, to a reference electrical energy parameter, an electrical energy parameter output by the target power supply, thereby achieving the balancing of the output electrical energy among the plurality of power supplies in the power supply system.

### CROSS-REFERENCE TO RELATED APPLICATIONS

The present application is a National Stage Entry under 35 U.S.C. § 371 of PCT International Application No. PCT/CN2025/118544, filed on Sep. 2, 2025, which claims priority to Chinese Patent Application No. 202510227356.7 filed to the China National Intellectual Property Administration on Feb. 27, 2025 and titled “POWER SUPPLY SYSTEM OF A SERVER”, the entire contents of each of which are incorporated herein by reference for all purposes

### TECHNICAL FIELD

The present application relates to the technical field of computers, and in particular, to a power supply system of a server.

### BACKGROUND

With the rapid development of internet technology and the continuous advancement of digital transformation, the data volume has experienced explosive growth, leading to a sharp increase in the demand for servers. Currently, due to the varying service volumes carried by the server during operation, the server has different operating states. Furthermore, the server has different electrical energy demands in different operating states. In order to better ensure the electrical energy requirements during server operation, in the related art, a power supply system constituted by a plurality of parallel-connected power supplies is deployed for the server, thereby uniformly distributing, on the plurality of power supplies, the electric energy required by the server. However, in the process of supplying power to the server by the power supply system, due to an impedance difference between each parallel-connected power supply and a server connection point, there is a significant difference in electrical energy output between the power supplies, causing damage to the power supplies, thus severely affecting the service life of the power supplies.

### SUMMARY

The present application provides a power supply system of a server, so as to at least solve the problem of low power supply control efficiency of a power supply in the related art.

The present application provides a power supply system of a server, including: a plurality of power supplies, wherein the plurality of power supplies are connected in parallel, and the power supply system is configured to be connected with a server.

The plurality of power supplies are configured to supply power to a target server according to a power supply requirement of the target server connected with the power supply system, wherein the power supply requirement is configured to indicate a required amount of electrical energy of the target server.

A target power supply among the plurality of power supplies is configured to adjust an electrical energy parameter of electrical energy output by the target power supply to a reference electrical energy parameter according to electrical energy parameters of electrical energy output by the plurality of power supplies and a power supply parameter of the power supply system, the power supply parameter is configured to indicate differences between electrical energy that the power supply system allows the plurality of power supplies to output.

By means of the present application, the plurality of parallel-connected power supplies are deployed in the power supply system of a server. When the server has a power supply requirement, according to the electrical energy parameters of electrical energy output by the power supplies and the power supply parameter of the power supply system, the target power supply among the plurality of power supplies adjusts the electrical energy parameter of electrical energy output by the target power supply to a reference electrical energy parameter, achieving the adjustment of the electrical energy parameters of electrical energy output by the plurality of power supplies according to the electrical energy parameters of electrical energy output by the plurality of power supplies and the differences in the electrical energy that the power supply system allows the plurality of power supplies to output, thereby ensuring the balancing of output electrical energy among the plurality of power supplies after the adjustment of the power parameters, and avoiding the problem of significant differences in the output electrical energy among the plurality of power supplies during the adjustment of the power parameters. Therefore, the technical problem of low power supply control efficiency of a power supply in the related art can be solved, and the technical effect of improving the power supply control efficiency of the power supply can be achieved.

### BRIEF DESCRIPTION OF THE DRAWINGS

The drawings to be used in embodiments will be briefly introduced below in order to illustrate the embodiments of the present application more clearly. Apparently, the drawings described below are only some embodiments of the present application. A person skilled in the art may obtain other drawings according to these drawings without creative work.

FIG. 1 is a hardware connection diagram of a power supply system of a server according to embodiments of the present application.

FIG. 2 is a schematic diagram of a parameter converter of a power supply system of a server according to embodiments of the present application.

FIG. 3 is a first schematic diagram of a filter circuit of a power supply system of a server according to embodiments of the present application.

FIG. 4 is a circuit connection diagram of a current filter of a power supply system of a server according to embodiments of the present application.

FIG. 5 is a circuit connection diagram of a first converter of a power supply system of a server according to embodiments of the present application.

FIG. 6 is a second schematic diagram of a filter circuit of a power supply system of a server according to embodiments of the present application.

FIG. 7 is a circuit connection diagram of a voltage filter of a power supply system of a server according to embodiments of the present application.

FIG. 8 is a circuit connection diagram of a second converter of a power supply system of a server according to embodiments of the present application.

FIG. 9 is a redundancy architecture diagram of a server power supply with dynamic current share mechanism according to embodiments of the present application.

FIG. 10 is a schematic diagram of dynamic current share according to embodiments of the present application.

FIG. 11 is an architecture block diagram of a power level switching power supply according to embodiments of the present application.

FIG. 12 is a schematic diagram of a digital power supply according to embodiments of the present application.

FIG. 13 is a block diagram of a digital power supply architecture according to embodiments of the present application.

FIG. 14 is a logic diagram of a dynamic adjustment according to embodiments of the present application.

FIG. 15 is a logic diagram of a dynamic adjustment of an output voltage according to embodiments of the present application.

FIG. 16 is a logic diagram of a dynamic adjustment of an output current according to embodiments of the present application.

FIG. 17 is a schematic diagram of a current share rate after dynamic adjustment according to embodiments of the present application.

FIG. 18 is a schematic diagram of a feedback adjustment circuit according to embodiments of the present application.

FIG. 19 is a schematic diagram of waveform influence according to embodiments of the present application.

FIG. 20 is a waveform diagram of a current resonance of power supplies connected in parallel according to embodiments of the present application.

FIG. 21 is a current dynamic damping architecture diagram according to embodiments of the present application.

FIG. 22 is a logic diagram of a dynamic current share and a damping function according to embodiments of the present application.

FIG. 23 is a schematic diagram of two detection paths of a damping module circuit according to embodiments of the present application.

FIG. 24 is a circuit schematic diagram of a damping module circuit according to embodiments of the present application.

FIG. 25 is a schematic diagram of level changes of a damping module circuit according to embodiments of the present application.

FIG. 26 is a circuit diagram of a comparator for an output current detection path of a damping module circuit according to embodiments of the present application.

FIG. 27 is an equivalent circuit diagram of a comparator for a current detection path according to embodiments of the present application.

FIG. 28 is a circuit diagram of a comparator for an output voltage detection path of a damping module circuit according to embodiments of the present application.

FIG. 29 is an equivalent circuit diagram of a comparator for a voltage detection path according to embodiments of the present application.

FIG. 30 is a waveform diagram when a damping module is used according to embodiments of the present application.

FIG. 31 is a waveform diagram of a dynamic current resonance phenomenon of power supplies connected in parallel according to embodiments of the present application.

FIG. 32 is a waveform diagram after the improvement of a resonance phenomenon according to embodiments of the present application.

### DETAILED DESCRIPTION OF THE EMBODIMENTS

The technical solution in the embodiments of this application will be clearly and completely described below with reference to the drawings in the embodiments of the present application. It is apparent that the described embodiments are merely part of the embodiments of the present application, not all the embodiments. All the other embodiments obtained by those of ordinary skill in the art on the basis of the embodiments in the present application without creative effort fall within the scope of protection of the present application.

It is to be noted that, in the description of the present application, terms “comprise”, “include” or any other variants are intended to encompass non-exclusive inclusion, such that a process, a method, an article or a device including a series of elements not only include those elements, but also includes other elements not listed explicitly or includes intrinsic elements for the process, the method, the article, or the device. Terms “first”, “second” and the like in the present application are configured to distinguish similar objects rather than describing a specific sequence or a precedence order.

Technical terms involved in the embodiments of the present application are explained below.
Server Power Supply Unit: Server PSU, or simply server power supply.
Central Processing Unit: CPU.
Graphics Processing Unit: GPU.
Microcontroller Unit: MCU.
Electric Design Peak Power: EDPp.
Power Redundancy: power redundancy.
Current share: referring to a process, in a circuit, of controlling, via a plurality of parallel-connected resistors or load devices, a current output by a power supply to uniformly flow through each resistor or load device.
Pulse-width modulation: referred to as PWM, is a technique for converting an analog signal into a pulse wave. Generally, the period of the converted pulse wave remains fixed, but the duty cycle of the pulse wave varies with the magnitude of the analog signal.
Duty Ratio (Duty Cycle): a concept in a plurality of fields such as radio frequencies, microwave circuits, low-frequency alternating current and direct current, etc., indicating a ratio of operating time to total time within one period.

In order to cause a person skilled in the art to better understand the solution of the present application, the present application is further described in detail below with reference to the drawings and the implementations.

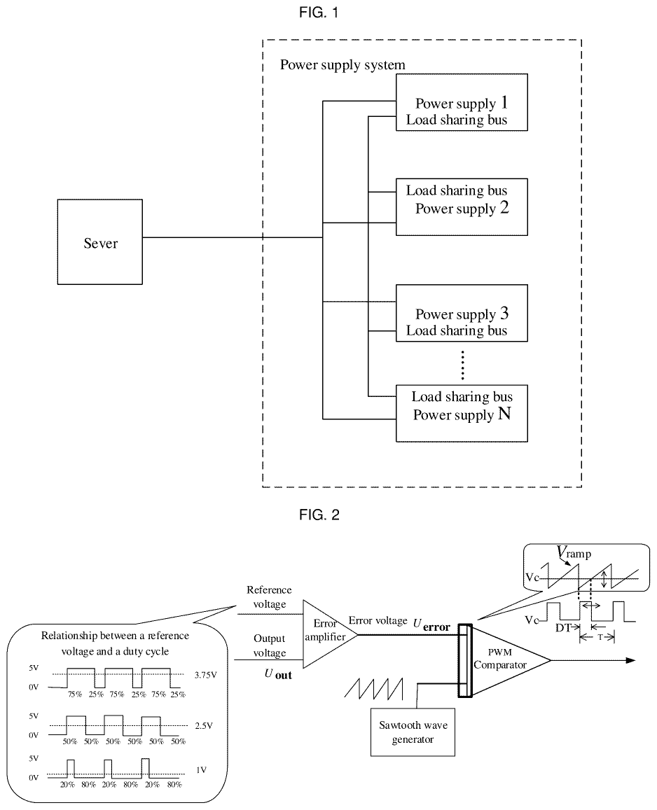

An embodiment of the present application provides a power supply system of a server. FIG. 1 is a hardware connection diagram of a power supply system of a server according to embodiments of the present application. As shown in FIG. 1, the system includes a plurality of power supplies, wherein the plurality of power supplies are connected in parallel, and the power supply system is configured to be connected with a server.

The plurality of power supplies are configured to supply power to a target server according to a power supply requirement of the target server connected with the power supply system, wherein the power supply requirement is configured to indicate a required amount of electrical energy of the target server.

A target power supply among the plurality of power supplies is configured to adjust an electrical energy parameter of electrical energy output by the target power supply to a reference electrical energy parameter according to electrical energy parameters of electrical energy output by the plurality of power supplies and a power supply parameter of the power supply system, wherein the power supply parameter is configured to indicate differences between electrical energy that the power supply system allows the plurality of power supplies to output.

By means of the present application, the plurality of parallel-connected power supplies are deployed in the power supply system of a server. When the server has a power supply requirement, according to the electrical energy parameters of electrical energy output by the power supplies and the power supply parameter of the power supply system, the target power supply among the plurality of power supplies adjusts the electrical energy parameter of electrical energy output by the target power supply to a reference electrical energy parameter, achieving the adjustment of the electrical energy parameters of electrical energy output by the plurality of power supplies according to the electrical energy parameters of electrical energy output by the plurality of power supplies and the differences in the electrical energy that the power supply system allows the plurality of power supplies to output, thereby ensuring the balancing of output electrical energy among the plurality of power supplies after the adjustment of the power parameters, and avoiding the problem of significant differences in the output electrical energy among the plurality of power supplies during the adjustment of the power parameters. Therefore, the technical problem of low power supply control efficiency of a power supply in the related art can be solved, and the technical effect of improving the power supply control efficiency of the power supply can be achieved.

Optionally, in the embodiments of the present application, each of the electrical energy parameters of electrical energy output by the plurality of power supplies is a parameter that is configured to indicate an electrical energy output state of a corresponding power supply of the plurality of power supplies. The electrical energy parameters may include, but is not limited to, a voltage value of voltage, a current value of current, and a power value of power, which are output by the power supply.

Optionally, in the embodiments of the present application, the power supply parameter of the power supply system is a parameter that is configured to indicate differences between currents or voltages that the power supply system allows, at a single time, the plurality of power supplies to output. The power supply parameter may include, but is not limited to, a load current share rate (namely current share rate) of a power supply or a voltage regulation rate of the power supply. The load current share rate of the power supply indicates, during a power supply process of the parallel-connected power supplies, a deviation between a current actually output by each power supply of the plurality of power supplies and a theoretical average current; and the voltage regulation rate indicates a change in a voltage actually output by each power supply of the plurality of power supplies in response to a change in a load current, as well as a change in a voltage actually output by each power supply of the plurality of power supplies in response to a change in an input voltage.

Optionally, in the embodiments of the present application, the plurality of power supplies are connected in parallel, such that the plurality of power supplies may share the electrical energy parameter of electrical energy by means of a connection relationship between the plurality of power supplies, and the target power supply can obtain not only its own electrical energy parameter of electrical energy but also the electrical energy parameters of electrical energy output by other power supplies among the plurality of power supplies. As shown in FIG. 1, the plurality of power supplies achieve a power supply load sharing function by connecting all load sharing bus pins together, such that any one of the plurality of power supplies in the power supply system can acquire, in real time, the current value or voltage value currently actually output by each power supply.

Optionally, in the embodiments of the present application, when the plurality of power supplies are connected in parallel to supply power to the same load (e.g., a CPU, GPU, or other components inside the server), an ideal electrical energy distribution should involve all power supplies sharing the electrical energy equally, for example, equal current share. This state is referred to as “current share” or “current sharing”. Electrical energy balance may prevent a failure caused by the overloading of a single power supply, ensuring the stability and redundancy of the power supply system. However, in practical applications, due to an individual difference between the power supplies (e.g., an impedance differences between the power supply and a server connection point), the current output of the power supplies may become significantly unbalanced, potentially leading to the shortened service life of the power supplies, thus affecting the stable operation of the entire server. The present application uses each power supply in the power supply system as its own master control. By collecting the current values of current or voltage values of voltage output in real time by the plurality of power supplies in the power supply system, as well as the power supply parameter of the power supply system itself, such as the load current share rate or the voltage regulation rate of the power supply, the current value of current output by each power supply itself is adjusted to approach an average current value output by the entire power supply system, or the voltage value of voltage output by each power supply itself is adjusted to approach a preset voltage value output by the entire power supply system, thereby achieving equal electrical energy sharing among all the power supplies.

Optionally, in the embodiments of the present application, the process that the target power supply adjusts its own electrical energy parameter to the reference electrical energy parameter is a multi-round iterative adjustment process that is accurately controlled on the basis of the electrical energy parameters of electrical energy output by the plurality of power supplies and the power supply parameter of the power supply system itself. The iterative adjustment process may be implemented by means of the following steps.

At S1, the target power supply acquires, via a load sharing bus, an electrical energy parameter of electrical energy currently output in real time by each of the plurality of power supplies in the power supply system, wherein the electrical energy parameter may include, but is not limited to, the current value or voltage value output by the power supply; and calculates first output electrical energy of the plurality of power supplies in the power supply system in a first adjustment round, wherein the first output electrical energy is configured to indicate an average output current value or a preset output voltage value of the plurality of power supplies in the power supply system in the first adjustment round.

At S2, the target power supply acquires a current power supply parameter of the power supply system, wherein the power supply parameter may include, but is not limited to, a load current share rate or a voltage regulation rate of the power supply.

At S3, the target power supply calculates, according to the first output electrical energy of the plurality of power supplies in the power supply system and the power supply parameter of the power supply system, a first electrical energy adjustment amount corresponding to the first adjustment round, and according to the first electrical energy adjustment amount, adjusts, a first electrical energy parameter of electrical energy currently output by the target power supply to a second electrical energy parameter.

At S41, in response to a difference value between the second electrical energy parameter and the first output electrical energy being less than a target difference threshold, an adjustment process is ended.

At S42, in response to the difference value between the second electrical energy parameter and the first output electrical energy being greater than or equal to the target difference threshold, a second adjustment round is initiated, and steps S1-S4 are repeated.

By means of the multi-round iterative adjustment process above, in the adjustment process above, each power supply in the power supply system serves as a master control device for adjusting its own electrical energy parameter of electrical energy. By performing multi-round iterative adjustment on its own electrical energy parameters of electrical energy on the basis of the electrical energy parameters of electrical energy output by the plurality of power supplies and the power supply parameter of the power supply system, the multi-round dynamic adjustment of the electrical energy parameters of electrical energy of the entire power supply system is realized. In each adjustment round, the target power supply can determine the electrical energy parameter adjustment amount for the current round according to the current actual output electrical energy of the plurality of power supplies in the power supply system and the power supply parameter (i.e., the electrical energy adjustment amount is determined according to an output state at the current moment, and the adjustment amounts in different rounds vary dynamically), so as to dynamically adjust the output electrical energy parameter of electrical energy to a reference electrical energy parameter, such that balanced current distribution can be effectively achieved in a multi-power supply parallel system. This process ensures that even if under conditions of dynamic changes (e.g., GPU overclocking) in system loads, the output electrical energy of each power supply can rapidly converge to the current average output electrical energy of the power supply system, thereby significantly reducing the problem of uneven electrical energy output among the power supplies, and improving the stability and power supply efficiency of the entire power supply system.

Optionally, in the embodiments of the present application, when the output electrical energy differences between the plurality of power supplies in the power supply system are significant, it may cause the actual output electrical energy of a portion of power supplies in the power supply system to exceed rated output electrical energy of the power supply, damaging power supply devices of the plurality of power supplies, thus affecting the service life of the plurality of power supplies. When there is a significant sudden change in the power supply requirement of the server, the electrical energy differences between the plurality of power supplies are relatively large, such that the target power supply among the plurality of power supplies may perform the following operations: an electrical energy variation amount of the electrical energy output by the target power supply in response to the power supply requirement is detected; in response to the electrical energy variation amount being greater than or equal to a target variation amount, the electrical energy parameters of electrical energy output by each of the plurality of power supplies is acquired; and the electrical energy parameters of electrical energy output by the target power supply is adjusted to the reference electrical energy parameter according to the electrical energy parameters of electrical energy output by the plurality of power supplies and the power supply parameter of the power supply system, wherein the power supply parameter is configured to indicate differences between electrical energy that the power supply system allows the plurality of power supplies to output. In this embodiment, the target variation amount may be a fixed value set on the basis of experience; or the target variation amount may also be determined according to the power supply parameter of the power supply system and the electrical energy parameters of electrical energy output by the plurality of power supplies at the current moment. Operations are performed as follows: an electrical energy output parameter of the power supply system is converted according to second power parameters of electrical energy output by the plurality of power supplies at the current moment, wherein the electrical energy output parameter is configured to indicate the electrical energy required to be output by any power supply in the power supply system in response to the power supply requirement; the target variation amount is determined according to the electrical energy output parameters of electrical energy output by the plurality of power supplies and the power supply parameter; in response to the second electrical energy parameter being a voltage value, a product value between a second voltage value and a voltage regulation rate is calculated to obtain a voltage adjustment amount, wherein the electrical energy output parameter includes the second voltage value, the power supply parameter includes the voltage regulation rate, and the electrical energy adjustment amount includes the voltage adjustment amount; in response to the second electrical energy parameter being a current value, a product value between a second current value and a current share rate (namely load current share rate) is calculated to obtain a current adjustment amount, wherein the electrical energy output parameter includes the second current value, the power supply parameter includes the current share rate, and the electrical energy adjustment amount includes the current adjustment amount.

As an optional embodiment, the target power supply includes a processor and a controller, wherein the processor is connected with the controller.

The processor is configured to generate, for the controller, an electrical energy adjustment amount of the target power supply according to target electrical energy parameters of electrical energy currently output by the plurality of the power supplies and the power supply parameter, until the electrical energy parameter of electrical energy output by the target power supply is adjusted to the reference electrical energy parameter, wherein the electrical energy adjustment amount is configured to indicate a difference value between electrical energy output by the target power supply before and after a current adjustment of the electrical energy parameter output by the target power supply.

The controller is configured to adjust, according to the electrical energy adjustment amount, the electrical energy output by the target power supply.

Optionally, in the embodiments of the present application, the processor is configured to acquire target electrical energy parameters of electrical energy output by the plurality of power supplies in the power supply system, such as an output current Io or an output voltage Vo of the power supply; acquire the power supply parameter of the power supply system, such as the load current share rate (namely current share rate) n (%) or the voltage regulation rate ¿ (%) of the power supply; and generate, for a controller, the electrical energy adjustment amount of the target power supply according to the target electrical energy parameter and the power supply parameter, wherein the electrical energy adjustment amount may include, but is not limited to, a current adjustment amount or a voltage adjustment amount.

Optionally, in the embodiments of the present application, the load current share rate (namely current share rate) η is defined as follows:

$$η ( \% ) = \frac{ΔIo\_DYNC}{Iave} * 1 \; 00 \% ;$$

Io is an output current of the power supply;
Iave is an average output current of the plurality of power supplies, which is an average of output currents of the plurality of power supplies:

$$Iave = \frac{{\sum }_{i = 1}^{n} {Io}_{i}}{n} ,$$

Ioᵢ is the output current of the ith power supply;
ΔIo_DYNC is a difference value of the output current of the power supply (i.e., the current adjustment amount generated according to the average output current and the load current share rate of the power supply), ΔIo_DYNC=Iave*n (%).

Optionally, in the embodiments of the present application, the voltage regulation rate & of the power supply is defined as follows:

$$ε ( \% ) = \frac{ΔVo\_DYNC}{Vmean} * 1 \; 00 \% ;$$

Vo is an output voltage of the power supply.

Vmean is an intermediate value of the output voltage of the power supply. For example, in a 12V power supply system, Vmean may be preset to 12V, indicating that a voltage level the power supply should maintain under a normal operating condition is 12V.

ΔVo_DYNC is a dynamic difference value of the output voltage of the power supply (i.e., the voltage adjustment amount generated according to the intermediate value of the output voltage of the power supply and the voltage regulation rate of the power supply), and ΔVo_DYNC=|Vo−Vmean|*ε(%).

Optionally, in the embodiments of the present application, the processor generates, for the controller, the electrical energy adjustment amount of the target power supply according to the target electrical energy parameter of electrical energy and the power supply parameter, until the process of adjusting, to the reference electrical energy parameter, the electrical energy parameter of electrical energy output by the target power supply is a multi-round iterative dynamic adjustment process.

At S1, in the first adjustment round, the processor acquires, via the load sharing bus, the output current Io or the output voltage Vo of each of power supplies in the power supply system, calculates the average output current Iave output by the power supplies or the intermediate value Vmean of the output voltage of the power supplies, and calculates the required first electrical energy adjustment amount according to the load current share rate n or the voltage regulation rate & required by the system.

At S2, the controller adjusts, according to the first electrical energy adjustment amount, an electrical energy parameter of electrical energy currently output by the target power supply, causing the current and voltage output after adjustment to be closer to Iave and Vmean.

At S3, after a plurality of iterations, a difference value between the current and voltage output by the target power supply and Iave and Vmean drops below the target difference threshold, and the output current and voltage of each power supply in the system tend to stabilize, achieving current share and voltage stabilization under a dynamic condition.

By means of the content above, the target power supply can rapidly respond to a load change in the power supply system, and dynamically adjust its own output electrical energy parameter, causing the output currents and voltages of the power supplies in the system to tend to balance, thereby significantly improving the current share performance and voltage stability of the power supply system.

As an optional embodiment, the controller includes: a filter circuit and a power supply circuit, wherein the power supply circuit is connected with the processor, and the power supply circuit is also connected with the filter circuit.

The power supply circuit is configured to operate according to a target operating parameter indicated by the electrical energy adjustment amount, to output first electrical energy.

The filter circuit is configured to detect a disturbance parameter of the first electrical energy, and generate a calibration parameter of the target operating parameter for the power supply circuit according to the disturbance parameter, wherein the disturbance parameter is configured to indicate a disturbance condition of power supply states of other power supplies among the plurality of power supplies other than the target power supply on a power supply state of the target power supply.

The power supply circuit is further configured to adjust the target operating parameter by using the calibration parameter, so as to obtain a reference operating parameter, and operate according to the reference operating parameter to output a second electrical energy.

Optionally, in the embodiments of the present application, the power supply circuit is configured to receive a target operating parameter that is indicated by the electrical energy adjustment amount calculated by the processor, such as a voltage target value or a current target value, and operate according to these parameters to output first electrical energy. During dynamic adjustment, the power supply circuit continuously adjusts its operating parameter according to the instruction from the processor, so as to output electrical energy that meets requirements of the power supply system.

Optionally, in the embodiments of the present application, due to a parallel connection relationship between the plurality of power supplies, a parallel resonance phenomenon may occur during the operation of the power supplies. Parallel resonance mainly occurs when the characteristics of inductive and capacitive components in the system interact with each other, and when the operating frequency of a circuit is close to its resonant frequency, sharp decreasing or increasing of circuit impedance is caused. This phenomenon may trigger significant current or voltage fluctuations, threatening the stability and safety of the system. When the power supply circuit operates according to the target operating parameter indicated by the electrical energy adjustment amount, the electrical energy output by the power supply circuit changes. Furthermore, a resonance factor leads to jitter of the electrical energy output of the power supply circuit. This jitter has a certain convergence period, and after the convergence period ends, stable electrical energy is output. In order to reduce the jitter convergence period, the present application designs the filter circuit. By monitoring and analyzing the disturbance parameter carried in the first electrical energy output by the power supply circuit, the disturbance parameter indicates a disturbed condition that is generated to the electrical energy output of the target power supply by the power supply states of the power supplies in the power supply system other than the target power supply, and may include, but are not limited to, electromagnetic interference (EMI) or resonance noise. By detecting the disturbance parameter, the filter circuit can identify unstable factors in the power supply parallel system, and generate the corresponding calibration parameter. The calibration parameter may include minor adjustment to the output voltage or current of the power supply circuit, as well as damping control strategies for resonance and EMI, for example, adjusting the duty cycle of a power supply converter or optimizing a voltage feedback loop, thereby reducing the jitter convergence period of the power supply circuit during output electrical energy adjustment.

Optionally, in the embodiments of the present application, the power supply circuit is further configured to further finely adjust its operating parameter according to the calibration parameter generated by the filter circuit, so as to obtain the more accurate reference operating parameter, ensuring that the output second electrical energy is more stable and balanced, thereby ultimately achieving rapid convergence of the output electrical energy parameter to an ideal state required by the system.

By means of the content above, the collaboration between the filter circuit and the power supply circuit can ensure the efficient and stable operation of the target power supply under the dynamic condition. In particular, the filter circuit can detect and analyze in real time the disturbance parameter during electrical energy output, generate the calibration parameters to optimize the operating state of the power supply circuit, and reduce a disturbance in the parallel system, thereby accelerating the convergence speed of dynamic adjustment of the system, and ensuring that the power supply can maintain stable and efficient electrical energy output even under a high dynamic load condition.

As an optional embodiment, the power supply circuit includes a parameter converter and a switching power supply, wherein the parameter converter is connected with the processor and the switching power supply, respectively.

The parameter converter is configured to generate an initial pulse-width signal corresponding to the electrical energy adjustment amount, wherein the target operating parameter includes the initial pulse-width signal.

The switching power supply is configured to, in response to the initial pulse-width signal, discharge according to a discharge state indicated by the initial pulse-width signal, and output the first electrical energy.

Optionally, in the embodiments of the present application, the parameter converter is configured to convert, into an initial pulse-width signal that can be understood and executed by the switching power supply, the electrical energy adjustment amount calculated by the processor. The initial pulse-width signal is a control signal, which is configured to instruct the switching power supply on how to adjust turn-on time in its switching period, that is, an “on” duration of a switching element. The pulse-width of the signal is proportional to the electrical energy adjustment amount. By adjusting the pulse-width, fine control of the output voltage and current of the power supply can be achieved, so as to meet requirements of dynamic load changes.

Optionally, in the embodiments of the present application, the switching power supply is configured to respond to the initial pulse-width signal to control a switching period of an internal switching component (e.g., an MOSFET), so as to adjust an output state of the power supply. When receiving the initial pulse-width signal output by the parameter converter, the switching power supply adjusts the turn-on time of the internal switching component according to the pulse-width of the signal. Such adjustment is dynamic, and may rapidly respond to fluctuations in system load, ensuring that the first electrical energy output by the power supply meets the set target operating parameter.

As an optional embodiment, the parameter converter is also connected with the filter circuit.

The parameter converter is further configured to adjust the initial pulse-width signal by using the received calibration parameter output by the filter circuit, so as to obtain a reference pulse-width signal.

The switching power supply is further configured to, in response to the reference pulse-width signal, discharge according to a discharge state indicated by the reference pulse-width signal, and output the second electrical energy.

Optionally, in the embodiments of the present application, the parameter converter not only receives the electrical energy adjustment amount of the processor, but also interacts with the filter circuit, so as to receive the calibration parameter from the filter circuit. The parameter converter adjusts the initial pulse-width signal according to the calibration parameter to ensure that the power supply output is not adversely affected by changes in the power supply states of other power supplies. The reference pulse-width signal after secondary adjustment includes the electrical energy adjustment amount and disturbance compensation information to compensate for a voltage or current deviation detected by the filter circuit, thereby providing a more accurate electrical energy output control instruction for the switching power supply.

Optionally, in the embodiments of the present application, the switching power supply is configured to respond to the reference pulse-width signal to further adjust the turn-on time of the internal switching component thereof, so as to output second electrical energy, wherein the second electrical energy refers to the power supply output after correction by the filter circuit and adjustment by the parameter converter, which not only responds to real-time load changes, but also compensates for the voltage and current deviation detected by the filter circuit, thereby achieving more stable and optimized electrical energy supply, and improving the performance and reliability of the entire power supply system.

As an optional embodiment, the parameter converter includes: a sawtooth wave generator, a first amplifier, a signal comparator, and a first reference power supply, wherein a first input end of the first amplifier is connected with the first reference power supply, a second input end of the first amplifier is connected with a signal output end of the filter circuit, a signal output end of the first amplifier is connected with a first input end of the signal comparator, a second input end of the signal comparator is connected with the sawtooth wave generator, and an output end of the signal comparator is connected with the switching power supply.

The first amplifier is configured to generate a calibration signal according to a reference voltage output by the first reference power supply and the calibration parameter output by the filter circuit.

The sawtooth wave generator is configured to generate a sawtooth wave signal corresponding to the electrical energy adjustment amount.

The signal comparator is configured to output a pulse-width signal according to the calibration signal and the sawtooth wave signal.

Optionally, in the embodiments of the present application, FIG. 2 is a schematic diagram of a parameter converter of a power supply system of a server according to embodiments of the present application. As shown in FIG. 2, the parameter converter includes a sawtooth wave generator, a first amplifier (i.e., an error amplifier in FIG. 2), a signal comparator (i.e., a PWM comparator in FIG. 2), and a first reference power supply, wherein a first input end of the first amplifier is connected with the first reference power supply, a second input end of the first amplifier is connected with a signal output end of the filter circuit, a signal output end of the first amplifier is connected with a first input end of the signal comparator, a second input end of the signal comparator is connected with the sawtooth wave generator, and an output end of the signal comparator is connected with the switching power supply.

Optionally, in the embodiments of the present application, the first amplifier is connected with the first reference power supply and the filter circuit, and is configured with generate a calibration signal to ensure accurate control of power supply output. The first amplifier receives a calibration parameter output by the filter circuit and a reference voltage output by the first reference power supply, and generates the calibration signal by means of amplification and adjustment.

Optionally, in the embodiments of the present application, the sawtooth wave generator is configured to receive an electrical energy adjustment amount generated by the processor, and convert the electrical energy adjustment amount into a corresponding sawtooth wave signal.

Optionally, in the embodiments of the present application, the signal comparator is configured to receive the calibration signal from the first amplifier and the sawtooth wave signal from the sawtooth wave generator. The signal comparator compares the two input signals. When the voltage of the calibration signal exceeds the voltage of the sawtooth wave signal, the signal comparator outputs a high level, and otherwise, outputs a low level. The comparison result determines the pulse-width of a PWM signal, further guiding the switching period of the switching power supply, namely the turn-on and turn-off time of the switching power supply, thereby achieving desired electrical energy output.

By means of the content above, the parameter converter achieves accurate dynamic control of power supply output by means of the collaborative operation of the sawtooth wave generator, the first amplifier, and the signal comparator. The parameter converter not only responds to the electrical energy adjustment amount of the processor, but also compensates for disturbances in the parallel power supply system by means of interaction with the filter circuit, ensuring the stability and current share performance of power supply output, thereby improving the efficiency and reliability of the entire system.

As an optional embodiment, the filter circuit includes: a current filter and a first converter, wherein an output end of the current filter is connected with an input end of the first converter, a current input end of the current filter is connected with a current output end of the power supply circuit, and an output end of the first converter is connected with the power supply circuit.

The current filter is configured to detect resonance noise values of the other power supplies according to a target current output by the power supply circuit, wherein the first electrical energy includes the target current, and the disturbance parameter includes the resonance noise values.

The first converter is configured to generate the calibration parameter corresponding to the resonance noise value.

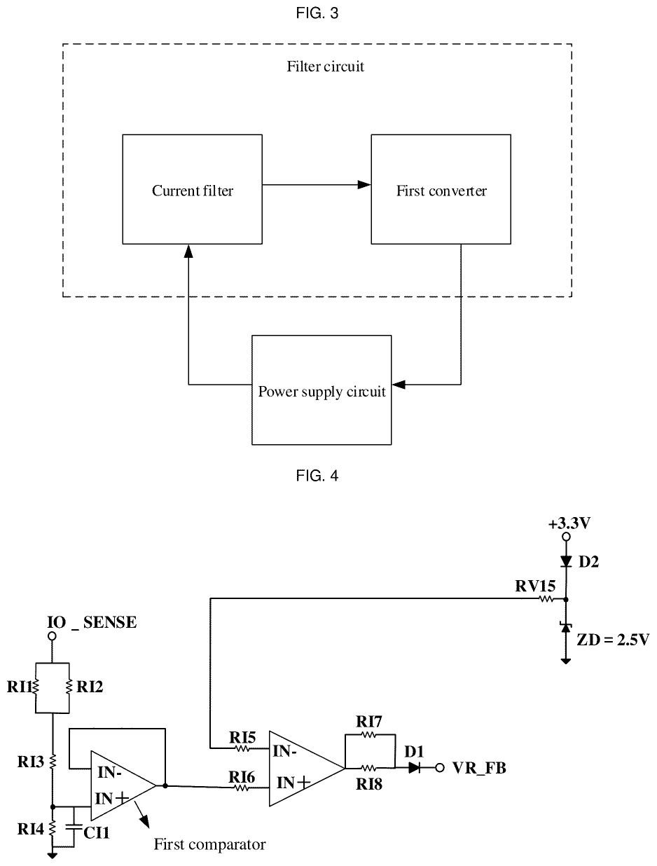

Optionally, in the embodiments of the present application, FIG. 3 is a first schematic diagram of a filter circuit of power supply system of a server according to embodiments of the present application. As shown in FIG. 3, the filter circuit includes: a current filter and a first converter, wherein an output end of the current filter is connected with an input end of the first converter, a current input end of the current filter is connected with a current output end of the power supply circuit, and an output end of the first converter is connected with the power supply circuit.

Optionally, in the embodiments of the present application, when the power supply circuit supplies power to a load, especially in a scenario in which a plurality of power supplies are connected in parallel, resonance noise caused by parallel connection of the power supplies or dynamic load changes may occur in the power supply system. The current filter is configured to filter out a high-frequency noise component from a target current signal, and extract a noise value related to resonance.

Optionally, in the embodiments of the present application, the first converter is configured to receive the resonance noise value from the current filter, and convert the value into the calibration parameter. The first converter may include, but is not limited to, a digital signal processor, a microcontroller, or other types of signal processing units. The first converter can convert a simulated noise value into a digital signal, and then generate the calibration parameter by means of algorithmic processing. The calibration parameter is configured to indicate how to adjust power supply output to counteract the impact of the resonance noise. The calibration parameter may include, but is not limited to, information for adjusting the duty cycle, frequency, or other control parameters of the PWM signal, so as to achieve accurate adjustment of power supply output, thereby reducing or eliminating the resonance noise.

By means of the content above, effective detection and compensation of the resonance noise in a parallel power supply system are achieved. The filter circuit can detect the resonance noise in real time, and guide dynamic adjustments of power supply output by generating the calibration parameter, thereby ensuring that the power supply system achieves more accurate and stable current output while maintaining the optimal performance of the power supply system and the server under dynamic load conditions.

As an optional embodiment, the current filter includes a first comparator, wherein a negative electrode input end of the first comparator is connected with an output end of the first comparator, a positive electrode input end of the first comparator is connected with the current output end of the power supply circuit, and an output end of the first comparator is connected with the input end of the first converter.

Optionally, in the embodiments of the present application, FIG. 4 is a circuit connection diagram of a current filter of a power supply system of a server according to embodiments of the present application. As shown in FIG. 4, the current filter includes the first comparator, wherein a negative electrode input end of the first comparator is connected with the output end to form a feedback loop, and the positive electrode input end of the first comparator is connected with the current output end of the power supply circuit, causing the first comparator to be able to adjust output according to a difference value between its output and the positive electrode input end (i.e., current output of the power supply circuit), thereby achieving dynamic current signal processing. The output end of the first comparator is connected with the input end of the first converter. When detecting noise or fluctuations in a current signal, the first comparator outputs, to the first converter, a signal for indicating the resonance noise value. The first converter generates, according to an output signal of the first comparator, a calibration parameter corresponding to the resonance noise value, so as to guide the parameter converter to adjust the PWM signal, thereby ensuring that the current output by the power supply is stable and meets system requirements.

By means of the content above, the current filter monitors and processes current output of the power supply circuit in real time via the first comparator, and utilizes a feedback mechanism to stabilize the current signal, so as to reduce the impact of the noise and fluctuations. The connection between the first comparator and the first converter causes a detected abnormal current to be able to be rapidly converted into the calibration parameter, so as to guide optimization and adjustment of power supply output.

As an optional embodiment, the first converter includes: a second comparator, a first resistor, a second resistor, and a second reference power supply, a first end of the first resistor is connected with the output end of the current filter, a second end of the first resistor is connected with a positive electrode input end of the second comparator, the second reference power supply is connected with a first end of the second resistor, a second end of the second resistor is connected with a negative electrode input end of the second comparator, and an output end of the second comparator is connected with the power supply circuit.

Optionally, in the embodiments of the present application, FIG. 5 is a circuit connection diagram of a first converter of a power supply system of a server according to embodiments of the present application. As shown in FIG. 5, the first converter includes: a second comparator, a first resistor (corresponding to R16 in FIG. 5), a second resistor (corresponding to the R15 in FIG. 5), and a second reference power supply, wherein a first end of the R16 is connected with the output end of the current filter, a second end is connected with a positive electrode input end of the second comparator, the second reference power supply is connected with a first end of the R15, a second end of the R15 is connected with a negative electrode input end of the second comparator, and an output end of the second comparator is connected with the power supply circuit.

Optionally, in the embodiments of the present application, when the positive electrode input end of the second comparator receives a signal output by the current filter, the second comparator compares the signal with a second reference power supply value received by the negative electrode input end. If the current signal deviates from a reference level set by the second reference power supply, the second comparator generates one calibration parameter corresponding to the resonance noise value, and the calibration parameter includes information on how to adjust the power supply circuit to counteract current fluctuations or noise.

Optionally, in the embodiments of the present application, the output end of the second comparator is directly connected with the power supply circuit. When the second comparator detects a difference between the current signal and a reference power supply value and generates a calibration parameter signal, the power supply circuit adjusts parameters such as the duty cycle, frequency, etc. of the PWM signal according to the calibration parameter signal, so as to achieve accurate control of current output, thereby ensuring that the current is stable and meets the system requirements.

By means of the content above, the first converter converts, into the calibration parameter by means of combining the second comparator, the first resistor, the second resistor, and the second reference power supply, the current fluctuations detected by the current filter, so as to guide the power supply circuit to perform accurate dynamic adjustment. Such design can effectively process the current fluctuations and noise in the server power supply system, improving the stability and current share performance of power output.

As an optional embodiment, the filter circuit includes: a voltage filter and a second converter, wherein an output end of the voltage filter is connected with an input end of the second converter, a voltage input end of the voltage filter is connected with a voltage output end of the power supply circuit, and an output end of the second converter is connected with the power supply circuit. The voltage filter is configured to detect resonance noise values of the other power supplies according to a target voltage output by the power supply circuit, wherein the first electrical energy includes the target voltage, and the disturbance parameter includes the resonance noise values. The second converter is configured to generate the calibration parameter corresponding to the resonance noise values.

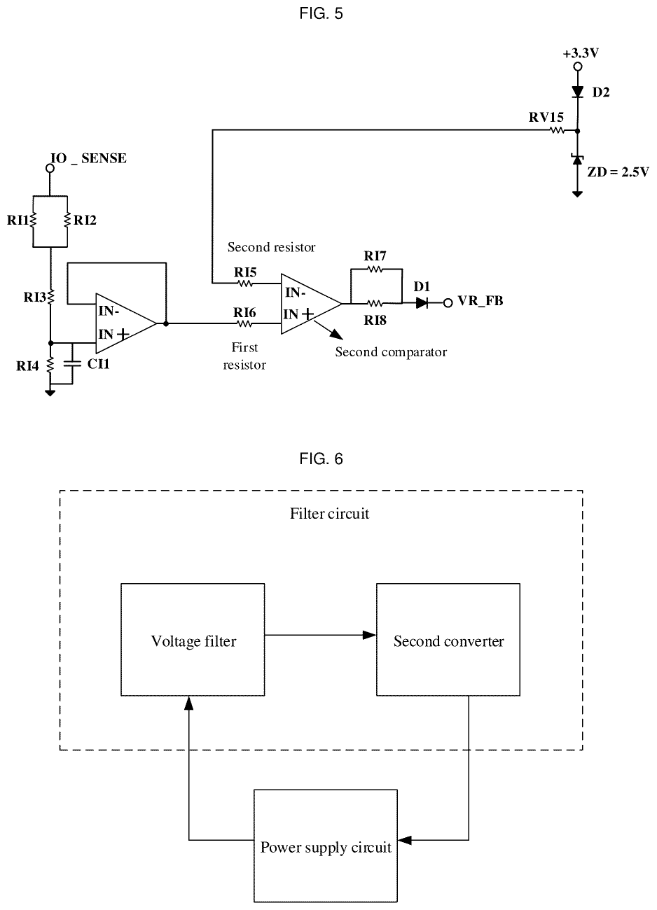

Optionally, in the embodiments of the present application, FIG. 6 is a second schematic diagram of a filter circuit of a power supply system of a server according to embodiments of the present application. As shown in FIG. 6, the filter circuit includes: a voltage filter and a second converter, wherein an output end of the voltage filter is connected with an input end of the second converter, a voltage input end of the voltage filter is connected with a voltage output end of the power supply circuit, and an output end of the second converter is connected with the power supply circuit.

Optionally, in the embodiments of the present application, in the server power supply system, particularly when the plurality of power supplies operate in parallel, due to a difference in electrical characteristics between the power supplies or instantaneous changes in dynamic loads (such as GPU/CPU overclocking), the output voltage of the power supply circuit may be subject to disturbance, resulting in a voltage fluctuation or resonance phenomenon. The voltage filter is configured to monitor and quantify the resonance noise present in the target voltage output by the power supply circuit.

Optionally, in the embodiments of the present application, the second converter receives the resonance noise value generated by the voltage filter, and converts the resonance noise value into the calibration parameter corresponding to the resonance noise for guiding the adjustment of the power supply circuit, so as to reduce or eliminate the impact of the resonance noise.

By means of the content above, the voltage filter monitors the resonance noise in the output voltage of the power supply circuit in real time, and then the second converter converts the resonance noise value into the corresponding calibration parameter to guide the optimization and adjustment of the power supply circuit, such that the voltage fluctuations and resonance noise in the output voltage can be effectively reduced, thereby improving the overall efficiency and reliability of the power supply system.

As an optional embodiment, the voltage filter includes: a third comparator, a third resistor, and a fourth resistor, wherein a positive electrode input end of the third comparator is connected with the voltage output end of the power supply circuit, a first end of the third resistor is connected with a negative electrode input end of the third comparator, a second end of the third resistor is connected with an output end of the third comparator, a first end of the fourth resistor is connected with a positive electrode input end of the third comparator, a second end of the fourth resistor is connected with the output end of the third comparator, and the output end of the third comparator is also connected with the input end of the second converter.

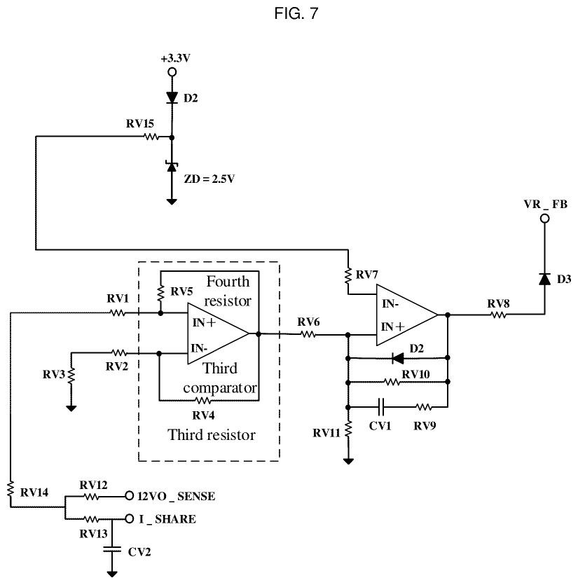

Optionally, in the embodiments of the present application, FIG. 7 is a circuit connection diagram of a voltage filter of a power supply system of a server according to embodiments of the present application. As shown in FIG. 7, the voltage filter includes the third comparator, the third resistor (corresponding to RV4 in FIG. 7), and the fourth resistor (corresponding to RV5 in FIG. 7).

Optionally, in the embodiments of the present application, the third comparator receives a voltage output signal of the power supply circuit and a reference level signal respectively via two input ends, and then generates an output signal on the basis of a comparison result of the two signals. The positive electrode input end of the third comparator is directly connected with the voltage output end of the power supply circuit, and is configured to monitor in real time an actual value of the output voltage of the power supply. The negative electrode input end receives a reference level via the third resistor. The reference level is a preset voltage standard, which is configured to compare with the output voltage of the power supply circuit to detect a voltage deviation or resonance noise, and generate the corresponding resonance noise value.

By means of the content above, the voltage filter is formed by integrating the third comparator, the third resistor, and the fourth resistor, and is configured to monitor and adjust the stability of the output voltage of the power supply circuit in real time. The third comparator detects the voltage deviation or resonance phenomenon by comparing the output voltage of the power supply circuit with a preset reference level. The third resistor and the fourth resistor are configured to achieve signal conditioning and voltage division, so as to ensure the accuracy and reliability of the output result of the third comparator. The second converter is configured to receive the output signal of the third comparator to generate the calibration parameter, so as to guide the power supply circuit to perform accurate voltage control, thereby improving the stability of voltage output of the parallel power supply system.

As an optional embodiment, the second converter includes: a fourth comparator, a third reference power supply, a fifth resistor, a sixth resistor, a seventh resistor, and a capacitor, wherein a first end of the fifth resistor is connected with a positive electrode input end of the fourth comparator, a second end of the fifth resistor is connected with an output end of the fourth comparator, a first end of the capacitor is connected with the positive electrode input end of the fourth comparator, a second end of the capacitor is connected with a first end of the sixth resistor, a second end of the sixth resistor is connected with the output end of the fourth comparator, a first end of the seventh resistor is connected with the positive electrode input end of the fourth comparator, a second end of the seventh resistor is grounded, the third reference power supply is connected with a negative electrode input end of the fourth comparator, and the output end of the fourth comparator is connected with the power supply circuit.

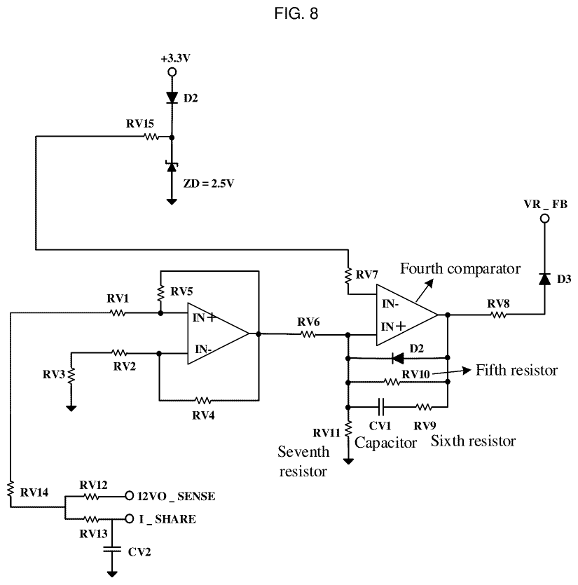

Optionally, in the embodiments of the present application, FIG. 8 is a circuit connection diagram of a second converter of a power supply system of a server according to embodiments of the present application. As shown in FIG. 8, the second converter includes the fourth comparator, the third reference power supply, the fifth resistor (corresponding to RV10 in FIG. 8), the sixth resistor (corresponding to RV9 in FIG. 8), the seventh resistor (corresponding to RV11 in FIG. 8), and the capacitor (corresponding to CV1 in FIG. 8).

Optionally, in the embodiments of the present application, when the positive electrode input end of the fourth comparator receives a signal output by the current filter, the fourth comparator compares the signal with a third reference power supply value received by the negative electrode input end. If the current signal deviates from a reference level set by a third reference power supply, the fourth comparator generates the calibration parameter corresponding to the resonance noise value output by the voltage filter, and the calibration parameter includes information on how to adjust the power supply circuit to counteract the voltage fluctuations or noise.

Optionally, in the embodiments of the present application, the output end of the fourth comparator is directly connected with the power supply circuit, such that the power supply circuit can receive the calibration parameter generated by the fourth comparator. The power supply circuit adjusts the duty ratio, frequency, or phase of the output voltage thereof according to the calibration parameter signal, so as to reduce the voltage deviations and eliminate the resonance noise, thereby ensuring the stability and reliability of the output voltage.

By means of the content above, the second converter, by means of combining the fourth comparator, the third reference power supply, the fifth resistor, the sixth resistor, the seventh resistor, and the capacitor, can effectively process the voltage deviations and noise information detected by the voltage filter, and generate the corresponding calibration parameter, so as to guide the power supply circuit to accurately adjust its output voltage.

As an optional embodiment, the processor is further configured to: generate an electrical energy output parameter of the power supply system according to the target electrical energy parameters, wherein the electrical energy output parameter is configured to indicate electrical energy required to be output, in response to the power supply requirement, by any power supply of the plurality of power supplies in the power supply system; and determine the electrical energy adjustment amount according to the electrical energy output parameter and the power supply parameter.

Optionally, in the embodiments of the present application, the target electrical energy parameter is configured to indicate an actual electrical energy output condition of the power supply. The target electrical energy parameter may include, but is not limited to, a current output value, voltage output value, supply power, etc. of the power supply.

Optionally, in the embodiments of the present application, the processor receives the target electrical energy parameters from the power supplies, and generates a comprehensive electrical energy output parameter according to the plurality of target electrical energy parameters and the power supply requirement of the system. The electrical energy output parameter is configured to indicate how much electrical energy (voltage, current, or power) each power supply should output under the current power supply requirement to maintain load balance of the power supply system. Therefore, the processor determines the electrical energy adjustment amount according to the electrical energy output parameters and the power supply parameter.

As an optional embodiment, the processor is further configured to: in response to the target electrical energy parameters being voltage values, calculate a product value between a reference voltage value and a voltage regulation rate to obtain a voltage adjustment amount, wherein the electrical energy output parameter includes the reference voltage value, the power supply parameter includes the voltage regulation rate, and the electrical energy adjustment amount includes the voltage adjustment amount.

In response to the target electrical energy parameters being current values, calculate a product value between a reference current value and a current share rate (namely load current share rate) to obtain a current adjustment amount, wherein the electrical energy output parameter includes the reference current value, the power supply parameter includes the current share rate, and the electrical energy adjustment amount includes the current adjustment amount.

Optionally, in the embodiments of the present application, in response to the target electrical energy parameter being the voltage value, the voltage adjustment amount is the product between the reference voltage value and the voltage regulation rate. The reference voltage value is configured to indicate a voltage level expected by the power supply system, and is typically set as a rated output voltage of the power supply, such as 12V output of a server power supply. Voltage adjustment amount=reference voltage value×voltage regulation rate. For example, if the reference voltage value is 12.2V and the voltage regulation rate is 5%, the voltage adjustment amount is 12.2V×5%=0.61V. That is, during a dynamic response process, if it is detected that the voltage deviates from a reference value by more than 0.61V, the processor generates an instruction to adjust the power supply in the power supply system, causing the output voltage to be adjusted within a specified range.

Optionally, in the embodiments of the present application, in response to the target electrical energy parameter being the current value, the current adjustment amount is the product between the reference current value and the current share rate. The reference current value is configured to indicate current output that the power supplies should have under balanced load conditions. Current adjustment amount=reference current value×current share rate. For example, assuming that the reference current value is Iave and the current share rate is 10%, the current adjustment amount is Iave×10%=0.1×Iave. This means that if it is detected that the current exceeds 10% of Iave, the processor generates an instruction to adjust the power supplies in the power supply system, causing the output current to be adjusted within a specified current share range.

As an optional embodiment, the processor is further configured to: in response to the target electrical energy parameters being current values, calculate an average value of the plurality of target electrical energy parameters to obtain a reference current value, wherein the electrical energy output parameter includes the reference current value.

In response to the target electrical energy parameters being voltage values, determine, from the electrical energy parameters and at least one voltage value which have a corresponding relationship, a reference voltage value corresponding to the target electrical energy parameters, wherein the electrical energy output parameter includes the reference voltage value.

Optionally, in the embodiments of the present application, when the target electrical energy parameter is the current value, the reference current value may include, but is not limited to, an average value of the plurality of target electrical energy parameters. The average value reflects an average current output condition of the power supply system at a certain moment, and is configured to guide each power supply in the power supply system to adjust the current output to close to the average value of the output current of the power supply system, thereby achieving overall current share and load balancing.

Optionally, in the embodiments of the present application, in response to the target electrical energy parameter being the voltage value, the reference voltage value corresponding to the target power parameter may be determined from the electrical energy parameter and the voltage value, which have the corresponding relationship. The corresponding relationship may be on the basis of a voltage output specification designed for the power supply system, a load change mode, historical operating data, and considerations of safety and efficiency. For example, for a 12V server power supply, a database of the processor includes voltage output requirements under different load conditions, as well as an emergency voltage adjustment strategy in a specific scenario (e.g., GPU overclocking).

By means of the content above, the processor generates the reference current value and the reference voltage value by calculating the average value of current values and determining the reference voltage value matching the voltage value, such that each power supply in the parallel power supply system can be guided to perform dynamic electrical energy adjustment, thereby adjusting the output current and voltage to a stable state expected by the power supply system.

In order to achieve a service processing function of the server, the server operates in different operating states, and electrical energy requirements of the server vary under different operating states. For example, some servers are provided with a plurality of Graphics Processing Units (GPUs) to support better computing power. Generally, a process that a GPU instantaneously increases its computing power is referred to as overclocking. Overclocking refers to improving the performance of the GPU by increasing the operating frequency (clock frequency) of the GPU, primarily affecting the core frequency and memory frequency of the GPU. The core frequency of the GPU directly affects its data processing speed. Overclocking, by means of increasing the core frequency, causes the GPU to be able to process more graphics computing tasks within the same time period. After the memory frequency is increased, a data transmission speed between the GPU and a memory is accelerated, facilitating improvement of rendering capabilities for high resolutions and large textures. By means of successful overclocking, a user experiences a higher frame rate or a faster computation speed in a GPU-intensive task such as gaming, 3D rendering, machine learning, etc. Overclocking causes the temperature of the GPU to increase significantly. If heat dissipation is insufficient, overheating may be caused, triggering protection mechanisms such as underclocking or automatic shutdown. Overclocking increases the power consumption of the GPU, leading to higher energy consumption. When the overlocking of the GPU occurs, the peak load Electric Design Peak Power (EDPp) reaches 155% of the maximum load of a PSU for 200 us, and there are concerns that the power supply support may trigger overcurrent protection (OCP). The power supply unit supports the overcurrent protection (OCP) at approximately 110% of the maximum load of the PSU for 1 s, with a peak load capability at about 140% for 100 us. Moreover, excessive power consumption and load easily cause significant voltage fluctuations and reduced stability, and excessive overclocking may lead to the instability of the system. In order to improve stability, the server typically adopt a Power Redundancy mechanism for the server power supply. Redundancy is constituted by a plurality of identical power supplies. When one power supply fails, another power supply may immediately take over its operation. After the power supply is replaced, the plurality of power supplies operate together again. The benefit of power supply redundancy is to achieve high stability of the server system. When one or two power supplies fail or fail to output for unknown reasons, the remaining power supplies in the system may continue to operate to provide electricity to the server system, preventing the server from crashing or shutting down due to power supply issues. In the power supplies implementing the redundancy function, a plurality of groups of currents are connected in parallel and output, making equal current distribution critically important. Therefore, a Current share (current sharing or current share) function is required to ensure that the current of each unit is output in a balanced manner. By means of the implementations above of the present application, active current share for the main output of the power supply system is achieved, with load current share within 10%, and each PSU operates within a range of 10%-20% of the rated load, with 5% tolerance >20% of the rated load. By performing redundant backup on one of the power supply failures, the operation and output of other power supplies are not affected. If an ISHARE Pin is uniformly short-circuited to ground, the power supply output shall comply with the specifications. However, in a server application using the GPU, due to the peak load EDPp during GPU overclocking, the dynamic response is extremely rapid, and attention needs to be paid to the potential for significant voltage fluctuations and reduced stability caused by excessive power consumption and load. Therefore, the implementation of “dynamic current share” evaluation is required, which poses a considerable challenge to server power supply design. The present application provides a software detection manner to achieve a dynamic current share mechanism.

Optionally, in the embodiments of the present application, a server power supply dynamic current share mechanism is further provided. This solution incorporates, into the Server PSU, firmware and hardware functions of “immediately adjusting the duty cycle of the converter to the optimal ratio and maintaining stable voltage output when instantaneous changes in output voltage and current become excessively large, as well as a rapid convergence damping module to quickly converge resonance during parallel connection”. The server power supply actively adjusts dynamic current share under GPU overclocking without any external commands, achieving a fast speed and high stability.

The implementation of this solution is divided into three major portions: (I) conditions and models for the dynamic current share phenomenon; (II) logic for determining abrupt changes in output voltage and current change amounts; (III) rapid convergence damping module.

### 1. Determination of Output Voltage and Current Change Amounts of Server PSU:

### (I) Conditions and Models for the Dynamic Current Share Phenomenon:

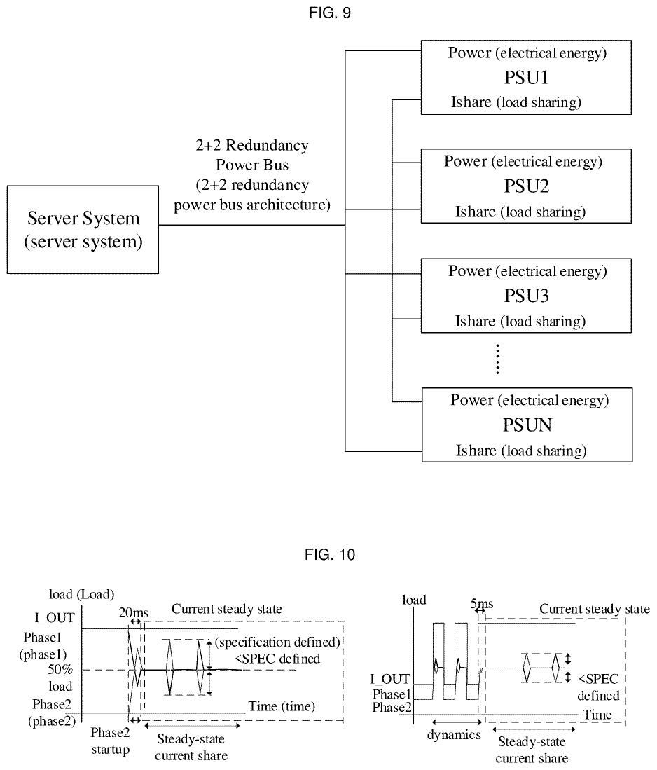

FIG. 9 is a redundancy architecture diagram of a server power supply with dynamic current share mechanism according to embodiments of the present application. As shown in FIG. 9, the main output connects all load sharing bus “ISHARE” pins together to enable an active load sharing function, so as to support active load sharing. N+N redundant power supply system, wherein the expected active load current and voltage regulation specifications for the PSU output are as follows:

(1) The current share rate n of the power supply is defined as follows:

$$η ( \% ) = \frac{ΔIo\_DYNC}{Iave} * 1 \; 00 \% ;$$

The load current share rate: η (%);
PSU output difference value: ΔIo_DYN_{C}=Iave*η (%);
PSU output current: Io;
PSU average output current:

$$Iave = \frac{{\sum }_{i = 1}^{n} {Io}_{i}}{n} ,$$

Ioᵢ is the output current of the ith power supply;

(2) The voltage regulation rate & of the power supply is defined as follows:

$$ε ( \% ) = \frac{ΔVo\_DYNC}{Vmean} * 1 \; 00 \% ;$$

The voltage regulation rate of the power supply: ε (%);
PSU output voltage: Vo;
PSU output intermediate value: Vmean, such as a 12V power supply is preset to 12.2V; PSU output dynamic difference value: ΔVo_DYNC=|Vo−Vmean|*ε (%);

(3) Power supply load current share rate and voltage regulation rate specifications:
a) within the operating range of each PSU, the current share rate n is <10%; and
b) within the operating range of each PSU, the voltage regulation rate & of the power supply is <5%.

At the beginning of system startup and when a new power supply is first put into service, and when the system CPU or GPU undergoes overclocking, the power supply experiences a dynamic change lasting approximately 20 ms. Therefore, it is necessary to perform convergence on two different scenarios of “system startup” and “system overclocking”. FIG. 10 is a schematic diagram of dynamic current share according to embodiments of the present application. As shown in FIG. 10:

System startup: after the new power supply (Phase 2) is powered on for 20 ms, the load current share rate and voltage regulation rate specifications of the power supply shall meet specification requirements.

System overclocking: after a dynamic current is switched to a steady state within 5 ms, the load current share rate and voltage regulation rate specifications of the power supply meet specification requirements.

Therefore, in the two scenarios, the current share rate is greater than 10% or the voltage regulation rate is greater than 5%, which is considered as the PSU being in a dynamic state.

In this case, a boundary condition for dynamic changes in PSU output is as follows:

### Output Current Change Amount:

$$10 \% = \frac{ΔIo\_DYNC}{Iave} * 100 \% \text{=>} 0.1 * Iave = ΔIo\_DYNC ;$$

### Output Voltage Change Amount:

$$5 \% - \frac{ΔVo\_DYNC}{Vmean} * 100 \% \text{=>} 0.05 * 12.2 = ΔVo\_DYNC \text{=>} 0.61 V = ΔVo\_DYNC$$

### 2. Logic for Determining Abrupt Changes in Output Voltage and Current Change Amounts:

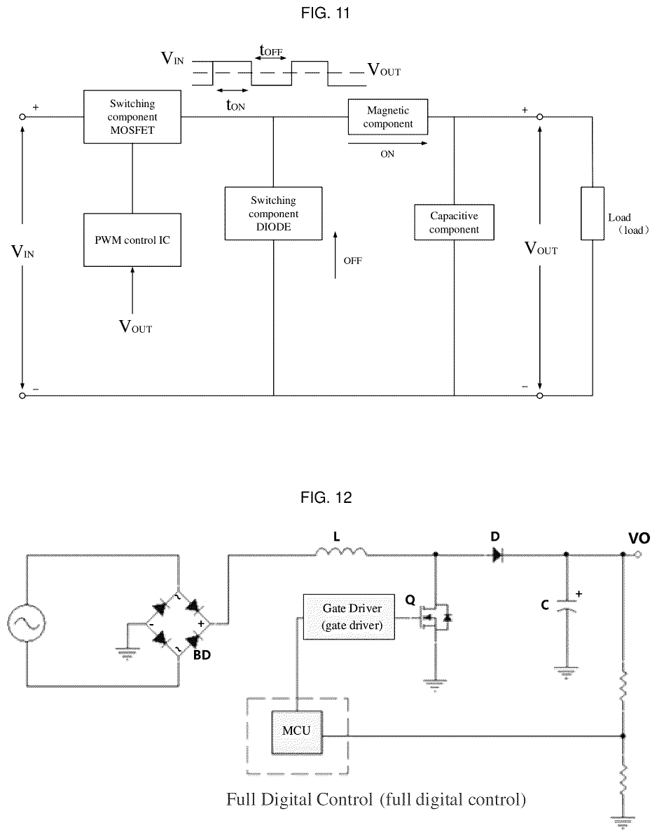

FIG. 11 is an architecture block diagram of a power level switching power supply according to embodiments of the present application. As shown in FIG. 11, the basic architecture of the switching power supply generally includes a pulse-width modulation (PWM) control IC, a switching component (MOSFET and DIODE), a magnetic component, and a capacitive component. For example, switching is performed between cutoff regions, wherein both modes have the characteristics of low dissipation, and the transition between switches causes higher dissipation but lasts for a very short duration, such that more energy is saved, and less waste heat is generated. However, the switching power supply is relatively complex, and MOS tubes switch frequently. If the switched current is not properly processed, it may generate noise and electromagnetic interference, affecting other devices. Moreover, if the switching power supply is specially designed, the power supply has a high power factor. The processing power of the switching power supply generally ranges from hundreds of watts to thousands of watts.

Pulse-width modulation is also referred to as PWM, is a technique for converting an analog signal into a pulse wave. Generally, the period of the converted pulse wave remains fixed, but the duty cycle of the pulse wave varies with the magnitude of the analog signal. As shown in FIG. 2, a pulse-width modulation (PWM) switching voltage regulator circuit, when an output frequency of a control circuit is constant, adjusts its duty cycle by means of voltage feedback, thereby achieving the purpose of stabilizing the output voltage.

FIG. 12 is a schematic diagram of a digital power supply according to embodiments of the present application. As shown in FIG. 12, a digital power supply uses a microprocessor to replace analog control on the basis of the design of an analog-controlled switching power supply; programmable power management is performed; and a software algorithm is configured to control the power supply system, achieving power supply control, management, monitoring, and communication functions that cannot be realized by the analog-controlled switching power supply, and achieving high flexibility. Therefore, it may ensure that various input voltages and various load conditions can achieve the best conversion efficiency.

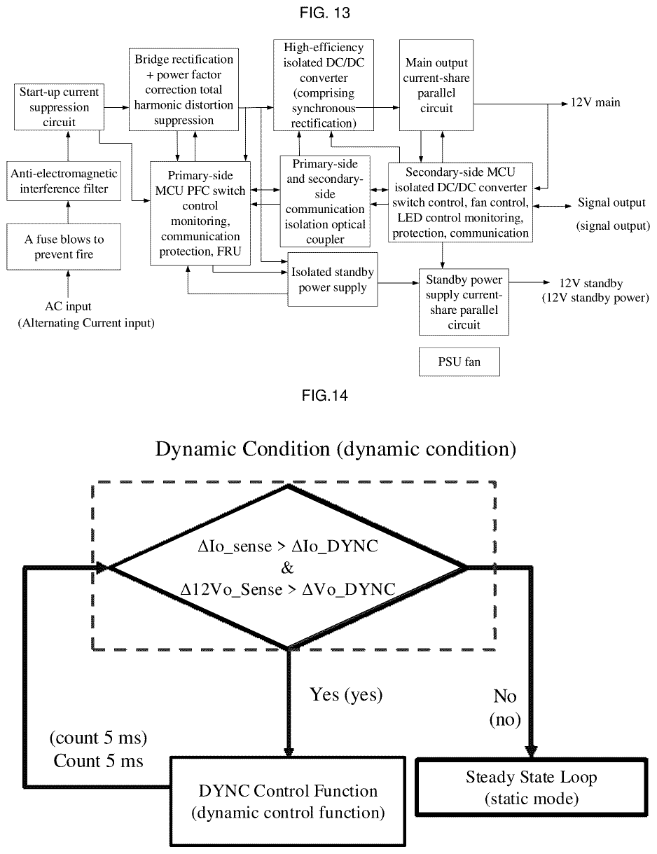

A current digital server power supply (Server PSU) uses an MCU to complete functions such as converter switch control, fan control, LED control, monitoring, protection, communication, etc. in the power supply unit. In terms of functional division, the functions are categorized into primary-side (PRIMARY Side) MCUs and secondary-side (SECONDARY Side) MCUs. FIG. 13 is a block diagram of a digital power supply architecture according to embodiments of the present application. As shown in FIG. 13, the current Server PSU uses the MCU to complete the functions such as converter switch control, fan control, LED control, monitoring, protection, communication, etc. in the power supply unit. In terms of functional division, the functions are categorized into the primary-side (PRIMARY Side) MCUs and the secondary-side (SECONDARY Side) MCUs. Current share and redundancy functions are both controlled and functionally implemented by the secondary-side (SECONDARY Side) MCU.

### 1) Software Adjustment Required During System Dynamic Adjustment:

By means of further analysis, the power supply dynamic current share function relies on compensation between 12V_ISHARE and IMON, and there is a voltage difference exists between the 12V_ISHARE and the IMON, resulting in problems with current share function compensation during dynamic testing. Therefore, an abnormal waveform occurs at 12V.

Therefore, the software adjustment logic is as follows:

When it is confirmed that the dynamic condition is met, the dynamic adjustment control function (DYNC Control Function) is activated. If the condition is not met, it remains in a steady state loop. FIG. 14 is a logic diagram of a dynamic adjustment according to embodiments of the present application. A management flow is as shown in FIG. 14. The dynamic condition is checked every 5 ms (the time is adjustable).

$$ΔIo\_sense > ΔIo\_DYNC ( ΔIo\_DYNC = 0.1 * Iave ) ;$$

$$Δ12 Vo\_Sense > ΔVo\_DYNC ( ΔVo\_DYNC = 0.61 ) ;$$

### 2) Determination and Correction of Entering Dynamic Adjustment Control Function (DYNC Control Function):

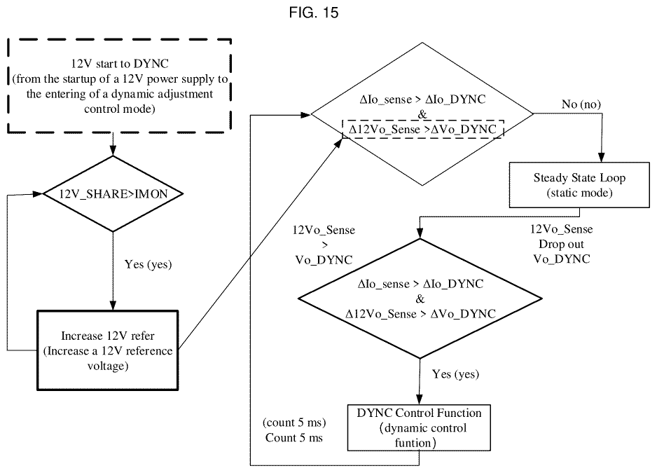

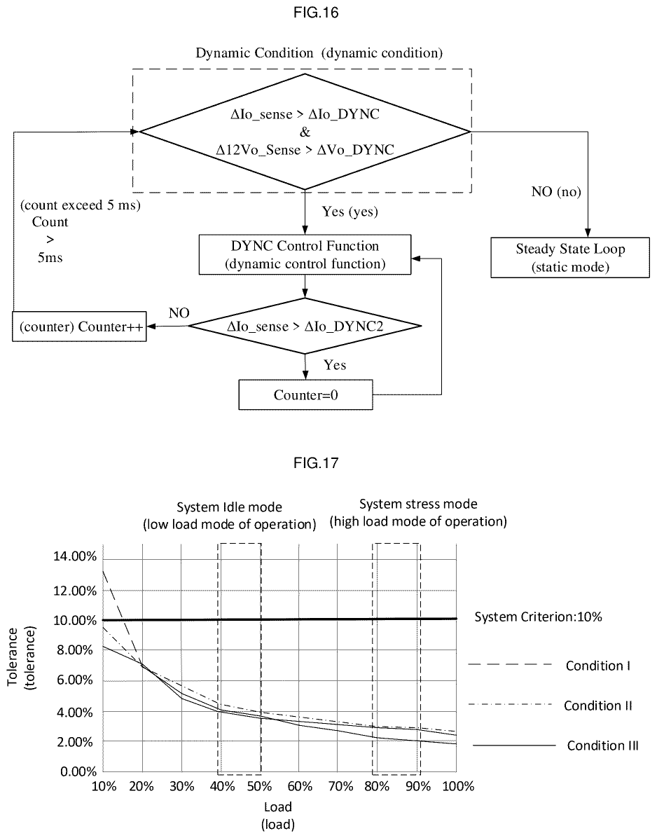

It is determined that when the dynamic adjustment control function is activated, it is necessary to ensure that a current feedback amount is greater than a dynamic mode current change amount ΔIo_sense>Io_DYNC, such that a voltage error value between the 12V_ISHARE and the IMON is counteracted, and counteraction is continuously performed during every 5 ms process, until the current feedback amount is less than the dynamic mode current change amount, thereby exiting the dynamic adjustment mode. FIG. 15 is a logic diagram of a dynamic adjustment of an output voltage according to embodiments of the present application. FIG. 16 is a logic diagram of a dynamic adjustment of an output current according to embodiments of the present application.

### 3) Post-Adjustment Testing:

An abnormal waveform occurs at 12V due to the addition of a current share control limit. Optimized firmware solves the 12V anomaly during dynamic testing. Whether the output voltage is normal during dynamic testing is verified. FIG. 17 is a schematic diagram of a current share rate after dynamic adjustment according to embodiments of the present application. As shown in FIG. 17, when dynamic adjustment of the power supply is achieved, the load current share rate is within 10%.

### 3. Rapid Convergence Damping Module:

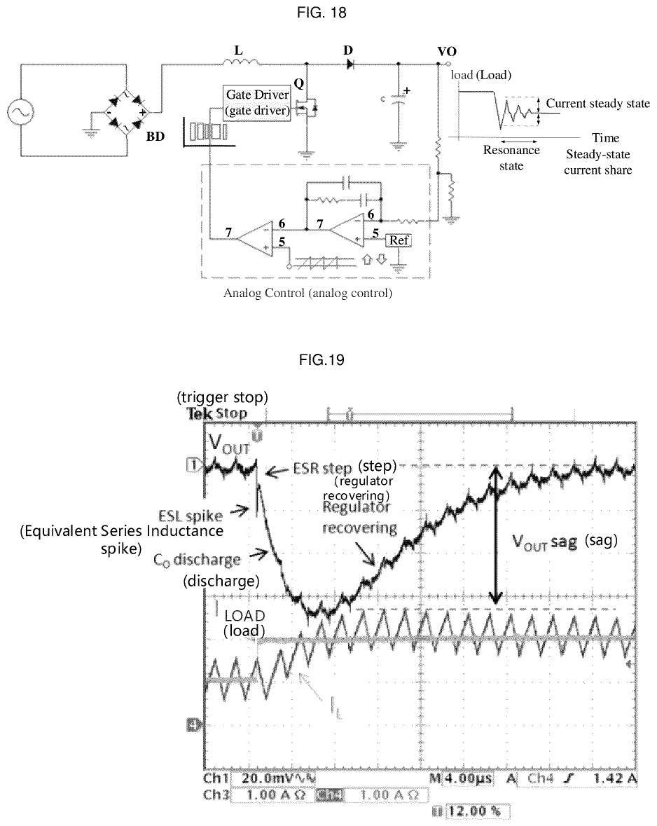

In applications involving parallel connection of the power supplies, the resonance phenomenon is a critical problem that requires focused attention. Parallel resonance mainly occurs when the characteristics of inductive and capacitive components in the system interact with each other, and when the operating frequency of a circuit is close to its resonant frequency, sharp decreasing or increasing of circuit impedance is caused. This phenomenon may trigger significant current or voltage fluctuations, threatening the stability and safety of the system. Due to output oscillation, feedback oscillation is caused. FIG. 18 is a schematic diagram of a feedback adjustment circuit according to embodiments of the present application. FIG. 19 is a schematic diagram of waveform influence according to embodiments of the present application.

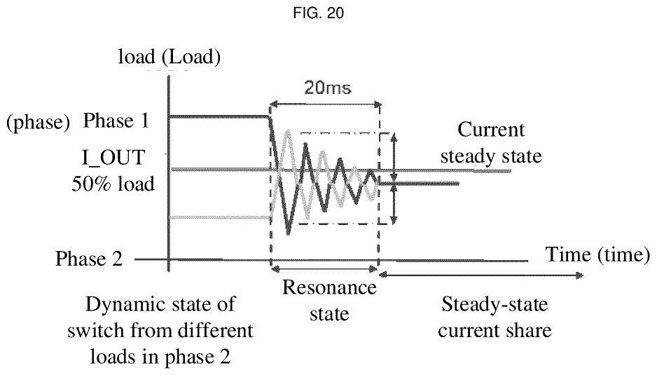

In practical applications, resonance may be triggered by the following factors: load changes, power grid fluctuations, or harmonic injection, etc. When the plurality of power supplies operate in parallel, the impact of resonance may become more complex due to different internal resistance and dynamic characteristics of each power supply. FIG. 20 is a waveform diagram of a current resonance of power supplies connected in parallel according to embodiments of the present application.

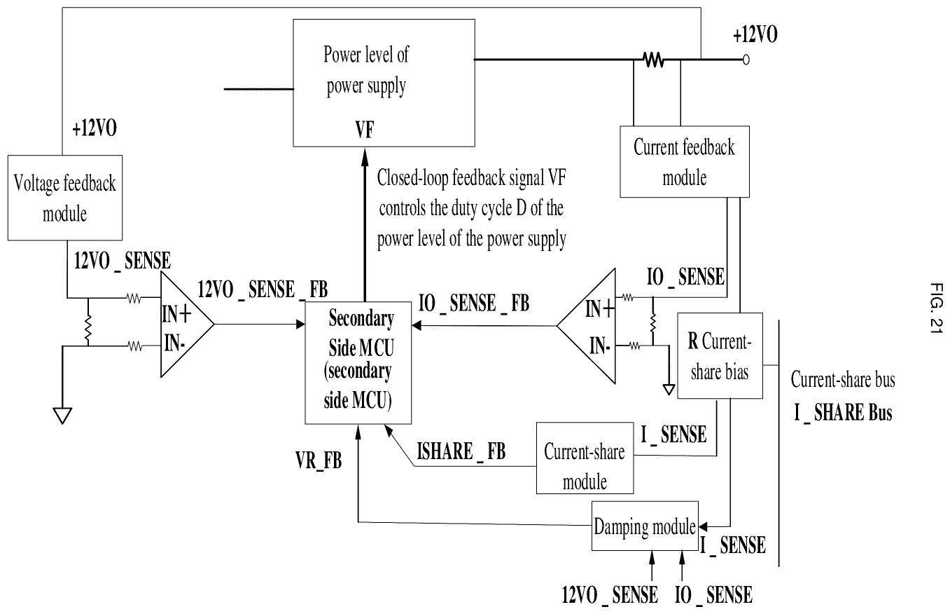

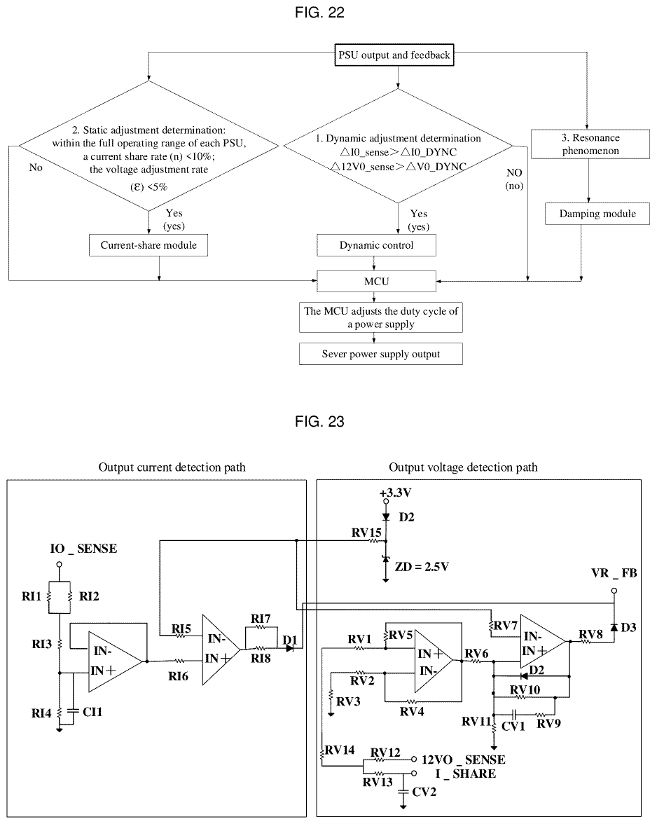

This not only causes mutual interference between the power supplies, but also may lead to device damage or reduced efficiency. In order to prevent resonance, it is necessary to optimize circuit design, add a damping circuit, avoid a resonance frequency range, or improve the stability of the system by adopting filtering measures, which is a key step in ensuring the reliability of parallel connection of the power supplies. This solution uses the rapid convergence damping module. FIG. 21 is a current dynamic damping architecture diagram according to embodiments of the present application. FIG. 22 is a logic diagram of a dynamic current share and a damping function according to embodiments of the present application.

FIG. 23 is a schematic diagram of two detection paths of a damping module circuit according to embodiments of the present application. As shown in FIG. 23, an output current detection path and an output voltage detection path are respectively configured to converge the impact of resonance on different dynamic characteristics of each power supply during power supply parallel operation, wherein the oscillation may be converged from dozens of times to 1-2 times.

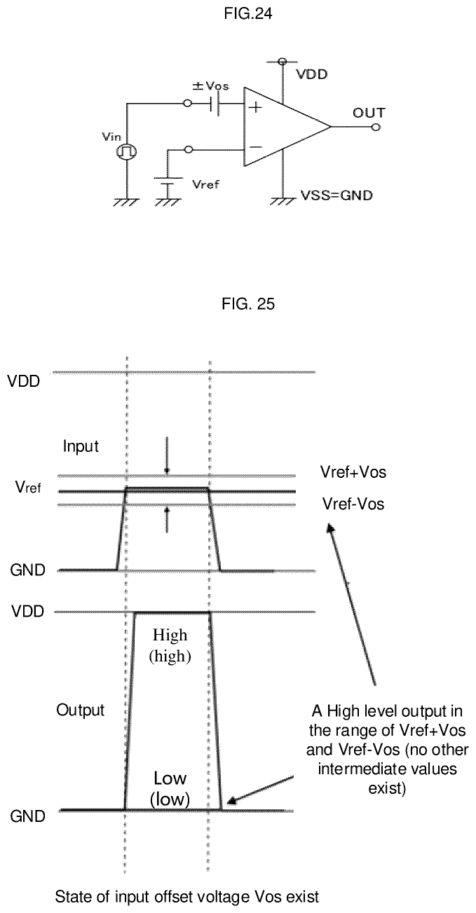

FIG. 24 is a circuit schematic diagram of a damping module circuit according to embodiments of the present application. As shown in FIG. 24, the damping module circuit is constituted by a comparator circuit, is configured to eliminate the impact of feedback oscillation on subsequent feedback, and may be divided into the output current detection path and the voltage output path. FIG. 25 is a schematic diagram of level changes of a damping module circuit according to embodiments of the present application. As shown in FIG. 25, this solution uses a dual-power-supply comparator circuit. By using Vref bias as a center, a comparison voltage is limited to the range of Vref+Vos and Vref-Vos. Within the range, the output is at a high level+VDD, in response to beyond the range, the output is at a low level VSS, such as ground at zero potential.

### Output Current Detection Path:

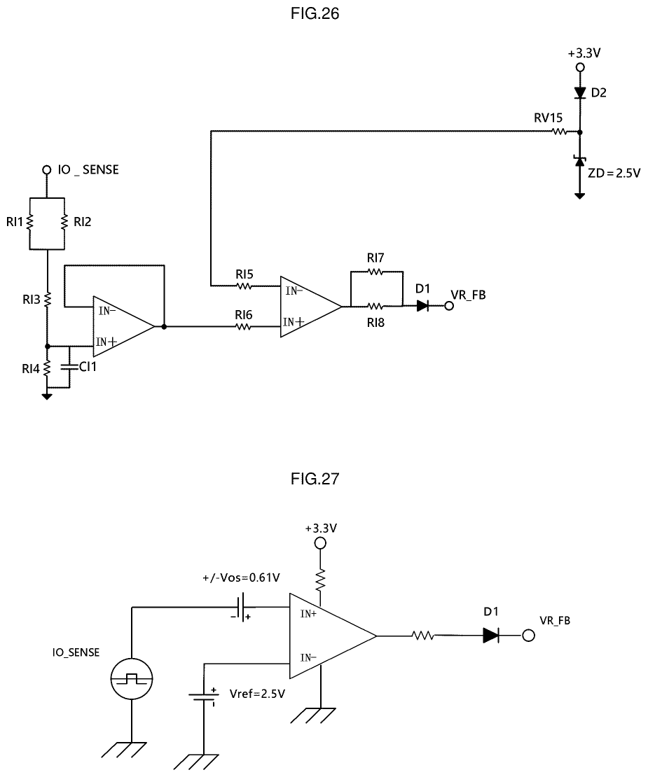

FIG. 26 is a circuit diagram of a comparator for an output current detection path of a damping module circuit according to embodiments of the present application. FIG. 27 is an equivalent circuit diagram of a comparator for a current detection path according to embodiments of the present application. FIG. 26 may be equivalent to FIG. 27 by means of simplification. When current input feedback is within the range of 2.5V+/−0.61V, the output is at a high level, and at a low level outside the range.

### Output Voltage Detection Path:

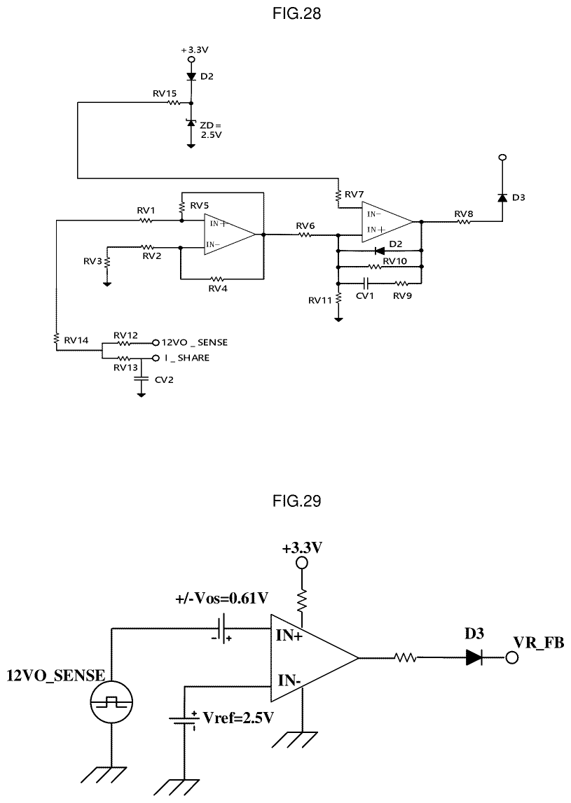

FIG. 28 is a circuit diagram of a comparator for an output voltage detection path of a damping module circuit according to embodiments of the present application. FIG. 29 is an equivalent circuit diagram of a comparator for a voltage detection path according to embodiments of the present application. FIG. 28 may be equivalent to FIG. 29 through simplification. When voltage input feedback is within the range of 2.5V+/−0.61V, the output is at a high level, and at a low level outside the range.

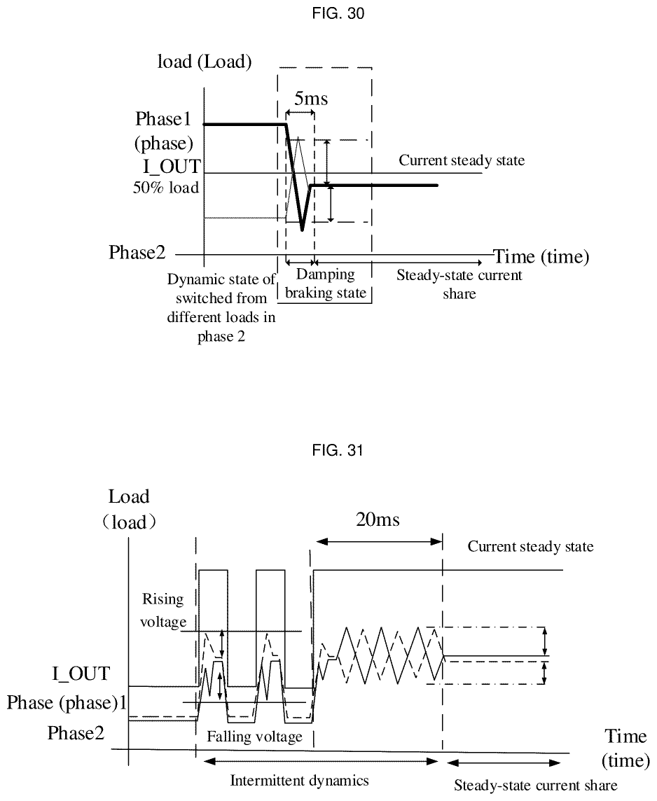

FIG. 30 is a waveform diagram when a damping module is used according to embodiments of the present application. As shown in FIG. 31, the damping module circuit primarily prevents resonance by maintaining a supply power feedback voltage as a stable direct current bias. Improving the resonance phenomenon during parallel connection of the power supplies can significantly improve the stability and reliability of the system, reducing damage to devices caused by the current or voltage fluctuations. By suppressing resonance, energy loss caused by high-frequency oscillation may be reduced, thereby improving overall efficiency. Moreover, electromagnetic interference can also be effectively reduced, thereby optimizing the operating environment of the power grid or system. For the long service life and performance consistency of the parallel-connected power supplies, suppression of the resonance is crucial. Ultimately, such optimization can ensure that the system operates more safely and more efficiently, meeting the power supply requirement of complex loads.

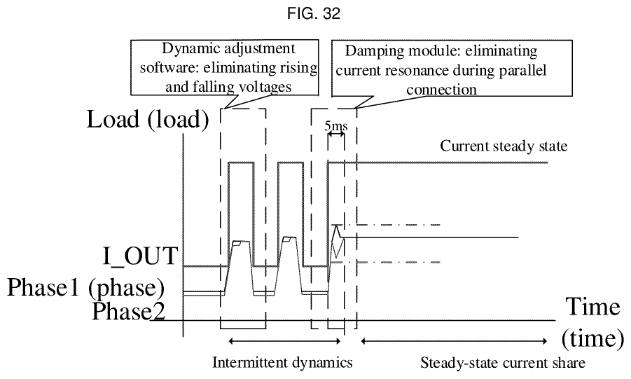

FIG. 31 is a waveform diagram of a dynamic current resonance phenomenon of power supplies connected in parallel according to embodiments of the present application. FIG. 32 is a waveform diagram after the improvement of a resonance phenomenon according to embodiments of the present application. When the server power supply generates a dynamic waveform to comply with GPU or CPU overclocking, the dynamic adjustment software and the rapid convergence damping module of the system in this solution are used, with an improvement effect shown in FIG. 32. The dynamic adjustment software of the system is used during startup overclocking of the CPU or GPU, so as to eliminate rising and falling voltages. Furthermore, the current resonance phenomenon during parallel connection is eliminated by using the rapid convergence damping module.

This solution has significant market potential. Sites in which a data center and server use a GPU card are all likely to experience the output voltage. During the overclocking of the GPU, the peak load EDPp is under a heavy load, leading to sudden voltage drops. This design method causes the power supply system to be more adaptable, maintainable, and cost-effective, and ensures the stability and reliability of the system under different load conditions.

By means of this solution, in an aspect, the software may perform dynamic adjustment according to real-time load changes, achieving more refined load balancing, thereby improving the overall efficiency and stability of the system. Moreover, the impact of the resonance on the system is reduced. Improving the resonance phenomenon during parallel connection of the power supplies can significantly improve the stability and reliability of the system, reducing damage to devices caused by the current or voltage fluctuations. By suppressing resonance, energy loss caused by high-frequency oscillation may be reduced, thereby improving overall efficiency. Moreover, electromagnetic interference can also be effectively reduced, thereby optimizing the operating environment of the power grid or system. For the long service life and performance consistency of the parallel-connected power supplies, suppression of the resonance is crucial.

In another aspect, by means of software adaptation, the power supply system may be better monitored and managed, rapid response to abnormal conditions is realized, reducing the probability of failures, thereby improving the reliability of the system. When the system needs to add a new function or adapt to a new load condition, the system may be expanded by software, and large-scale modification to hardware is not required, thereby improving the scalability of the system. No additional hardware setup or special capacitance values are required, and the function may be added to an existing architecture and firmware. Moreover, this solution does not utilize special technologies or novel materials, and thus has low advancement performance. The providing of the firmware and hardware design effectively solve the problem of dynamic adjustment, demonstrating highly innovative concept. The design feasibility of the embodiments is 100%, and the related technologies used are mature existing mass-production technologies.

From the above descriptions about the implementation modes, a person skilled in the art may clearly know that the method according to the foregoing embodiments may be implemented in a manner of combining software and a necessary universal hardware platform, and of course, may also be implemented through hardware, but the former is a preferred implementation mode under many circumstances.

The professional may further realize that the units and algorithmic steps of the various examples described in combination with the embodiments disclosed herein are capable of being implemented in electronic hardware, computer software, or a combination of electronic hardware and computer software. In order to clearly illustrate the interchangeability of hardware and software, the composition and the steps of the examples have been described in the above description in general terms according to functions. Whether these functions are performed by means of a hardware or a software depends on particular applications and design constraints of the technical solution. Professional technicians can implement the described function using different methods for each particular application, but such implementation should not be considered as going beyond the scope of the present application.

The server power supply system provided in the present application is introduced in detail above. Detailed examples are used in this specification to describe the principles and implementations of the present application. The description of the above embodiments is merely used to facilitate understanding of the core idea of the present application. It should be noted that for a person of ordinary skill in the art, without departing from the principles of the present application, several improvements and modifications may be made to the present application, which also fall within the scope of protection of the claims of the present application.

1. A power supply system of a server, comprising:
a plurality of power supplies, wherein the plurality of power supplies are connected in parallel, and the power supply system is configured to connect with a server;
the plurality of power supplies are configured to supply power to a target server according to a power supply requirement of the target server connected with the power supply system, the power supply requirement is configured to indicate a required amount of electrical energy of the target server; and
a target power supply among the plurality of power supplies is configured to adjust an electrical energy parameter of electrical energy output by the target power supply to a reference electrical energy parameter according to electrical energy parameters of electrical energy output by the plurality of power supplies and a power supply parameter of the power supply system;
wherein the power supply parameter is configured to indicate differences between currents or voltages that the power supply system allows, at a single time, the plurality of power supplies to output, and the power supply parameter comprises a load current share rate or a voltage regulation rate;
wherein each of the electrical energy parameters is configured to indicate an electrical energy output state of a corresponding power supply of the plurality of power supplies,
wherein a difference value between electrical energy output by the target power supply after the target power supply operates according to the reference electrical energy parameter and average of electrical energy output by the plurality of power supplies is less than a preset threshold;
wherein the target power supply comprises a processor and a controller, and the processor is connected with the controller; the processor is configured to generate, for the controller, an electrical energy adjustment amount of the target power supply according to target electrical energy parameters of electrical energy currently output by the plurality of power supplies and the power supply parameter, until the electrical energy parameter of electrical energy output by the target power supply is adjusted to the reference electrical energy parameter, wherein the electrical energy adjustment amount is configured to indicate a difference value between electrical energy output by the target power supply before and after a current adjustment of the electrical energy parameter output by the target power supply; and the controller is configured to adjust, according to the electrical energy adjustment amount, the electrical energy output by the target power supply; wherein the controller comprises a filter circuit and a power supply circuit; the power supply circuit is connected with the processor, and the power supply circuit is also connected with the filter circuit; the power supply circuit is configured to operate according to a target operating parameter indicated by the electrical energy adjustment amount, to output first electrical energy; the filter circuit is configured to detect a disturbance parameter of the first electrical energy, and generate a calibration parameter of the target operating parameter for the power supply circuit according to the disturbance parameter, the disturbance parameter is configured to indicate a disturbance condition of power supply states of other power supplies among the plurality of power supplies other than the target power supply on a power supply state of the target power supply; and the power supply circuit is further configured to adjust the target operating parameter by using the calibration parameter, to obtain a reference operating parameter, and operate according to the reference operating parameter, to output a second electrical energy.

2-3. (canceled)

4. The power supply system according to claim 1, wherein
the power supply circuit comprises a parameter converter and a switching power supply, and the parameter converter is connected with the processor and the switching power supply, respectively;
the parameter converter is configured to generate an initial pulse-width signal corresponding to the electrical energy adjustment amount, wherein the target operating parameter comprises the initial pulse-width signal; and
the switching power supply is configured to, in response to the initial pulse-width signal, discharge according to a discharge state indicated by the initial pulse-width signal, and output the first electrical energy.

5. The power supply system according to claim 4, wherein the parameter converter is also connected with the filter circuit;
the parameter converter is further configured to adjust the initial pulse-width signal by using the received calibration parameter output by the filter circuit, to obtain a reference pulse-width signal; and
the switching power supply is further configured to, in response to the reference pulse-width signal, discharge according to a discharge state indicated by the reference pulse-width signal, and output the second electrical energy.

6. The power supply system according to claim 5, wherein
the parameter converter comprises: a sawtooth wave generator, a first amplifier, a signal comparator, and a first reference power supply, wherein a first input end of the first amplifier is connected with the first reference power supply, a second input end of the first amplifier is connected with a signal output end of the filter circuit, a signal output end of the first amplifier is connected with a first input end of the signal comparator, a second input end of the signal comparator is connected with the sawtooth wave generator, and an output end of the signal comparator is connected with the switching power supply;
the first amplifier is configured to generate a calibration signal according to a reference voltage output by the first reference power supply and the calibration parameter output by the filter circuit;
the sawtooth wave generator is configured to generate a sawtooth wave signal corresponding to the electrical energy adjustment amount; and
the signal comparator is configured to output a pulse-width signal according to the calibration signal and the sawtooth wave signal.

7. The power supply system according to claim 1, wherein
the filter circuit comprises: a current filter and a first converter, an output end of the current filter is connected with an input end of the first converter, a current input end of the current filter is connected with a current output end of the power supply circuit, and an output end of the first converter is connected with the power supply circuit;
the current filter is configured to detect resonance noise values of the other power supplies according to a target current output by the power supply circuit, the first electrical energy comprises the target current, and the disturbance parameter comprises the resonance noise values; and
the first converter is configured to generate the calibration parameter corresponding to the resonance noise values.

8. The power supply system according to claim 7, wherein
the current filter comprises a first comparator, a negative electrode input end of the first comparator is connected with an output end of the first comparator, a positive electrode input end of the first comparator is connected with the current output end of the power supply circuit, and an output end of the first comparator is connected with the input end of the first converter.

9. The power supply system according to claim 8, wherein
the first converter comprises: a second comparator, a first resistor, a second resistor, and a second reference power supply, a first end of the first resistor is connected with the output end of the current filter, a second end of the first resistor is connected with a positive electrode input end of the second comparator, the second reference power supply is connected with a first end of the second resistor, a second end of the second resistor is connected with a negative electrode input end of the second comparator, and an output end of the second comparator is connected with the power supply circuit.

10. The power supply system according to claim 1, wherein
the filter circuit comprises: a voltage filter and a second converter, an output end of the voltage filter is connected with an input end of the second converter, a voltage input end of the voltage filter is connected with a voltage output end of the power supply circuit, and an output end of the second converter is connected with the power supply circuit;
the voltage filter is configured to detect resonance noise values of the other power supplies according to a target voltage output by the power supply circuit, the first electrical energy comprises the target voltage, and the disturbance parameter comprises the resonance noise values; and
the second converter is configured to generate the calibration parameter corresponding to the resonance noise values.

11. The power supply system according to claim 10, wherein
the voltage filter comprises: a third comparator, a third resistor, and a fourth resistor, a positive electrode input end of the third comparator is connected with the voltage output end of the power supply circuit, a first end of the third resistor is connected with a negative electrode input end of the third comparator, a second end of the third resistor is connected with an output end of the third comparator, a first end of the fourth resistor is connected with a positive electrode input end of the third comparator, a second end of the fourth resistor is connected with the output end of the third comparator, and the output end of the third comparator is also connected with the input end of the second converter.

12. The power supply system according to claim 11, wherein
the second converter comprises: a fourth comparator, a third reference power supply, a fifth resistor, a sixth resistor, a seventh resistor, and a capacitor, a first end of the fifth resistor is connected with a positive electrode input end of the fourth comparator, a second end of the fifth resistor is connected with an output end of the fourth comparator, a first end of the capacitor is connected with the positive electrode input end of the fourth comparator, a second end of the capacitor is connected with a first end of the sixth resistor, a second end of the sixth resistor is connected with the output end of the fourth comparator, a first end of the seventh resistor is connected with the positive electrode input end of the fourth comparator, a second end of the seventh resistor is grounded, the third reference power supply is connected with a negative electrode input end of the fourth comparator, and the output end of the fourth comparator is connected with the power supply circuit.

13. The power supply system according to claim 1, wherein
the processor is further configured to: generate an electrical energy output parameter of the power supply system according to the target electrical energy parameters, wherein the electrical energy output parameter is configured to indicate electrical energy required to be output, in response to the power supply requirement, by any power supply of the plurality of power supplies in the power supply system; and determine the electrical energy adjustment amount according to the electrical energy output parameter and the power supply parameter.

14. The power supply system according to claim 13, wherein the processor is further configured to:
in response to the target electrical energy parameters being voltage values, calculate a product value between a reference voltage value and a voltage regulation rate to obtain a voltage adjustment amount, wherein the electrical energy output parameter comprises the reference voltage value, the power supply parameter comprises the voltage regulation rate, and the electrical energy adjustment amount comprises the voltage adjustment amount; and
in response to the target electrical energy parameters being current values, calculate a product value between a reference current value and a current share rate to obtain a current adjustment amount, wherein the electrical energy output parameter comprises the reference current value, the power supply parameter comprises the current share rate, and the electrical energy adjustment amount comprises the current adjustment amount.

15. The power supply system according to claim 13, wherein the processor is further configured to:
in response to the target electrical energy parameters being current values, calculate an average of the target electrical energy parameters to obtain a reference current value, wherein the electrical energy output parameter comprises the reference current value; and
in response to the target electrical energy parameters being voltage values, determine, from electrical energy parameters and at least one voltage value which have a corresponding relationship, a reference voltage value corresponding to the target electrical energy parameters, wherein the electrical energy output parameter comprises the reference voltage value.

16-18. (canceled)

19. The power supply system according to claim 1, wherein the plurality of power supplies are connected via a load sharing bus, and the plurality of power supplies are configured to share the electrical energy parameters via the load sharing bus.

20. The power supply system according to claim 19, wherein the target power supply is configured to: acquire, via the load sharing bus, an electrical energy parameter of electrical energy currently output in real time by each of the plurality of power supplies in the power supply system; calculate first output electrical energy of the plurality of power supplies in the power supply system in a first adjustment round; acquire a current power supply parameter of the power supply system; according to the first output electrical energy of the plurality of power supplies in the power supply system and the current power supply parameter of the power supply system, calculate a first electrical energy adjustment amount corresponding to the first adjustment round, and according to the first electrical energy adjustment amount, adjust a first electrical energy parameter of electrical energy currently output by the target power supply to a second electrical energy parameter; in response to a difference value between the second electrical energy parameter and the first output electrical energy being less than a target difference threshold, end an adjustment process; and in response to the difference value between the second electrical energy parameter and the first output electrical energy being greater than or equal to the target difference threshold, initiate a second adjustment round.
